(19) United States
(12) Patent Application Publication
(10) Pub. No.: US 2026/0073438 A1
(43) Pub. Date: Mar. 12, 2026

(54) PLATFORM FOR COUTURE AND READY-TO-WEAR FASHION PURCHASES AND SALES

(71) Applicants: Ugochukwu Ekpemu, Cypress, TX (US); Uzoamaka Ekpemu, Cypress, TX (US); Ijeoma Nwokeohuru, Perth Amboy, NJ (US); Gbemisola Adewuya, Houston, TX (US)

(72) Inventors: Ugochukwu Ekpemu, Cypress, TX (US); Uzoamaka Ekpemu, Cypress, TX (US); Ijeoma Nwokeohuru, Perth Amboy, NJ (US); Gbemisola Adewuya, Houston, TX (US)

(21) Appl. No.: 19/393,154

(22) Filed: Nov. 18, 2025

Related U.S. Application Data
(63) Continuation-in-part of application No. 19/092,231, filed on Mar. 27, 2025.
(60) Provisional application No. 63/570,528, filed on Mar. 27, 2024.

(51) Int. Cl. G06Q 30/0601; G06Q 10/0833; G06Q 30/018; G06T 7/60

(52) U.S. Cl. CPC G06Q 30/0621; G06Q 10/0833; G06Q 30/0185; G06Q 30/06311; G06T 7/60

(57) ABSTRACT

A platform for connecting couture and ready-to-wear fashion inclined clients with fashion designers through fashion designer vendors wherein the fashion designer vendors provide the fashion products for the client, the fashion products including quality custom-made clothing. The platform includes a space for fashion designer vendors to display fabrics on sale, a message board for the fashion designer vendors and a message board for the client. The fashion designer vendors create a profile on the platform, including a shipping profile. The client selects at least one designer as a preferred designer to allow the platform to provide a preferred fashion selection from the platform. The platform includes steps to coordinate selection, purchase and delivery of products from the fashion designer vendors to the client.

### CROSS-REFERENCE TO RELATED APPLICATIONS

This Utility patent application claims priority to U.S. patent application Ser. No. 19/092,231, filed Mar. 27, 2025, which in turn claims priority to U.S. Provisional Patent Application No. 63/570,528, filed Mar. 27, 2024. Both prior applications are incorporated herein by reference in their entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

All trademarks referenced in this disclosure are the property of their respective owners, and the applicant makes no claim of ownership to such marks.

### BACKGROUND OF THE INVENTION

### 1) Field of the Invention

The present disclosure relates to digital marketplace platforms for fashion commerce, and more particularly to an AI-powered global fashion marketplace platform that connects consumers with designers and tailors for custom clothing orders, fabric sales, and ready-to-wear purchases through integrated communication, measurement, and verification systems.

### 2) Description of Related Art

There is currently a lack of couture and ready-to-wear fashion available on platforms which provide fashion pairing for clients and fashion designers. Existing e-commerce platforms do not adequately support couture and ready-to-wear fashion transactions in which clients are paired with designers or tailors based on style preferences and fit requirements. There are no systems currently available which makes it easy for a client to view and purchase couture and ready-to-wear fashion products what suit the client tastes and purchase abilities. There is a need for a system that enables end-to-end transaction management for couture and ready-to-wear fashion, including product discovery, selection, sizing, purchase, and order fulfillment. The platform should have the ability to correctly size the products for the client as well as include all aspects of the purchase including creating a profile for both the fashion design vendors and the client. Current platforms often lack integrated security protocols for transaction protection and do not provide scheduling features for design consultations or fittings. The platform should include security protocols and the ability to make appointments.

The fashion industry has experienced substantial growth in digital commerce, with consumers increasingly seeking personalized and custom clothing options through online platforms. Traditional fashion retail models have evolved to accommodate demand for bespoke tailoring services, custom design consultations, and direct connections between consumers and independent designers or tailors across global markets.

Digital marketplace platforms for fashion commerce face various challenges in facilitating effective communication between consumers and service providers. Existing platforms provide limited tools for consumers to communicate design preferences, capture precise body measurements, or verify the credibility of designers or tailors, which creates challenges in cross-border fashion commerce. The process of commissioning custom clothing typically involves multiple touchpoints including initial consultations, design discussions, measurement collection, fabric selection, progress updates, and final delivery coordination.

Existing fashion marketplace platforms may lack integrated systems for streamlining the custom order workflow from initial discovery through final delivery. Many platforms operate with fragmented communication channels, requiring users to coordinate across separate systems for messaging, video consultations, payment processing, and order tracking. Additionally, the measurement collection process for custom clothing often relies on manual entry methods that may be prone to user error or require in-person fittings that limit geographic accessibility.

Trust and verification mechanisms represent another area of consideration in digital fashion marketplaces. Consumers may have concerns about the authenticity and qualifications of designers or tailors when engaging in custom clothing transactions, particularly for higher-value orders or when working with service providers in different geographic regions. Similarly, designers and tailors may seek platforms that provide verification systems to establish credibility and differentiate their services in competitive marketplaces.

The integration of artificial intelligence technologies in fashion commerce platforms has emerged as an area of development, with potential applications in personalized recommendations, automated customer service, and enhanced user experiences. Such technologies may offer opportunities to address some of the communication and workflow challenges present in traditional custom fashion ordering processes.

### BRIEF SUMMARY OF THE INVENTION

The instant invention in one form is directed to a platform for connecting fashion inclined clients with fashion designers through fashion designer vendors wherein the fashion designer vendors provide the fashion products for the client, the fashion products including quality custom-made clothing. The platform includes a space for fashion designer vendors to display fabrics on sale, a message board for the fashion designer vendors and a message board for the client. The fashion designer vendors create a profile on the platform, including a shipping profile. The client selects at least one designer as a preferred designer to allow the platform to provide a preferred fashion selection from the platform. The platform includes steps to coordinate selection, purchase and delivery of products from the fashion designer vendors to the client.

According to an aspect of the present disclosure, a digital fashion marketplace platform is provided. The platform comprises a server system configured to host a global fashion marketplace connecting consumers with designers and tailors. The server system includes a user interface module configured to facilitate user registration and authentication for both consumers and fashion service providers. The platform includes a designer portfolio management system configured to enable designers and tailors to create and maintain digital portfolios showcasing their work and services. The server system incorporates a custom order workflow engine configured to process custom clothing requests through flexible communication options including direct messaging and scheduled consultations. The platform includes an artificial intelligence-powered body measurement system configured to analyze user-provided images to generate body measurements for custom clothing orders. The server system includes a real-time communication module configured to facilitate text messaging, image sharing, and video consultations between consumers and designers. The platform incorporates a verification system configured to authenticate designer credentials through document processing and verification services. The server system includes an artificial intelligence chatbot configured to provide automated customer assistance and product recommendations. The platform includes a recommendation engine configured to analyze user behavior data to generate personalized suggestions for designers, fabrics, and designs. The server system incorporates a fabric and product marketplace module configured to facilitate sales of fabrics, ready-to-wear clothing, and accessories. The platform includes a review and rating system configured to enable verified purchasers to rate and review designers and completed orders. The server system includes a notification system configured to generate contextual pop-up messages and push notifications based on user interaction patterns and order status updates.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a flowchart of a process for first-time users interacting with the digital fashion marketplace, according to aspects of the present disclosure.

FIG. 2 shows a method for browsing and discovering designers and styles based on user preferences and filters.

FIG. 3 outlines a process for initiating, revising, and approving custom clothing orders through interactive channels.

FIG. 4 illustrates an AI-powered body measurement system based on user-provided imagery.

FIG. 5 presents a communication workflow enabling real-time chat and video consultations between users and designers.

FIG. 6 details a Know Your Customer (KYC) verification method for authenticating designer credentials.

FIG. 7 displays a method for delivering automated assistance via an integrated AI chatbot system.

FIG. 8 represents an AI-driven recommendation engine that personalizes design and product suggestions.

FIG. 9 illustrates a process for purchasing fabrics, ready-to-wear garments, and fashion accessories.

FIG. 10 illustrates a method for reviews and ratings, according to aspects of the present disclosure.

FIG. 11 illustrates a flow for handling abandoned browsing and no-purchase scenarios, according to aspects of the present disclosure.

FIG. 12 illustrates a flow diagram of a process for handling incomplete consultation bookings, according to aspects of the present disclosure.

FIG. 13 illustrates a process for order delivery progress updates, according to aspects of the present disclosure.

FIG. 14 shows a flowchart of the platform according to the present invention; and

FIG. 15 shows a flowchart of an example of a customer in a specific location sourcing customized clothing.

The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The following detailed description provides specific implementations of the invention to enable those skilled in the art to practice its various aspects. While certain embodiments are illustrated for clarity, they are not intended to limit the scope of the invention. The features described in relation to one embodiment may be combined with features of other embodiments, unless stated otherwise. Additionally, some elements may be omitted from certain embodiments without departing from the core principles of the invention. Descriptive language is provided to aid in understanding the system and method; however, the invention is not limited to the precise components, sequences, or interactions presented. Terminology such as “module,” “engine,” or “system” is used broadly to encompass software, hardware, or a combination of both. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application, the use of the singular includes the plural unless specifically stated otherwise, and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise. Singular terms include the plural, and vice versa. The term “or” should be interpreted as “and/or,” unless context clearly dictates otherwise. Similarly, “including,” “includes,” and related terms are intended to be non-exclusive. References to “components,” “modules,” or “elements” may refer to singular units or combinations thereof, implemented in hardware, software, or both.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

### Mobile App/Website

The platform offers a versatile cross-platform experience through its mobile app and website. Designed with user convenience in mind, both platforms provide seamless access to a wide range of features aimed at connecting customers with designers/vendors worldwide.

### Features:

User-Friendly Interface: The mobile app and website feature intuitive interfaces, making navigation effortless for users of all levels of tech-savviness.

Profile Creation: Users can easily create personalized profiles, providing essential information such as contact details, style preferences, and measurement specifications.

Customization Tools: The platform offers robust customization tools, allowing customers to articulate their clothing requirements through detailed descriptions, design images, and measurement inputs.

Designer/Vendor Selection: Customers have the freedom to browse through a diverse selection of designers/vendors, exploring their portfolios and specialties before making an informed decision.

Communication Channels: Direct communication channels, including messaging and video boards, facilitate seamless collaboration between customers and designers/vendors throughout the design process.

Secure Payment Gateway: A secure payment gateway ensures safe and hassle-free transactions, offering multiple payment options to suit individual preferences.

Order Tracking: Customers can track the progress of their orders in real-time, receiving notifications at each stage of the production and delivery process.

Feedback and Rating System: Upon receiving their custom-made clothing, customers can provide feedback and ratings based on their experience, contributing to a transparent and trustworthy community ecosystem.

Virtual Fitting Room: AI technology captures body measurements and enables clients to try on clothing virtually.

### How it Works:

1. Account Creation: Users begin by creating a personalized account on the mobile app or website, providing essential information and preferences. The user interface module prompts a new user to submit identifying information, preferences, and login credentials. This data is processed by the account creation engine and stored in the user profile database.

2. Clothing Requirements: Users articulate their clothing requirements through detailed descriptions, design images, and measurement inputs, utilizing the platform's customization tools.

3. Designer/Vendor Selection: Users browse through a diverse selection of designers/vendors, exploring their portfolios and specialties before making a selection.

4. Collaboration: Direct communication channels facilitate seamless collaboration between users and designers/vendors throughout the design process, ensuring clarity and alignment of vision.

5. Secure Transactions: Upon order finalization and acceptance, the transaction gateway module handles the financial transaction using a third-party payment processor. Payment metadata is encrypted and stored in accordance with PCI DSS guidelines. Users complete transactions securely through the platform's payment gateway, with multiple payment options available to suit individual preferences.

6. Order Tracking and Feedback: Users can track the progress of their orders in real-time and provide feedback and ratings upon receiving their custom-made clothing, contributing to a transparent and trustworthy community ecosystem.

The platform operates on a business-to-consumer (B2C) basis, directly engaging with users and vendors within the fashion industry. The business model revolves around charging subscription fees, transaction fees, and other fees for add-on services to both customers and designers/vendors. These fees ensure sustainable revenue generation while providing users and vendors with access to a wide range of features and services aimed at enhancing their custom clothing experience. Leveraging this B2C model fosters a thriving ecosystem where individuals can seamlessly connect, collaborate, and create bespoke fashion pieces tailored to their unique preferences and styles. The platform employs a business-to-consumer (B2C) transactional model wherein registered consumers interact directly with fashion service providers, including designers, tailors, and vendors. Monetization mechanisms include: Subscription-Based Access to enhanced platform features or premium visibility tiers; Transaction Fees applied to successful orders processed through the system; Add-On Services, such as AI-driven virtual fitting, expedited order processing, or promotional placements for designers. These revenue channels are integrated within the platform's architecture via a billing module that associates fees with user actions, order states, or service tiers. The system further maintains role-based access control to regulate feature availability by user type (e.g., basic user vs. premium vendor). This model enables a self-sustaining digital ecosystem supporting global, asynchronous collaboration between users and fashion service providers.

The digital fashion marketplace platform comprises a comprehensive system that connects consumers with global designers and tailors through artificial intelligence-powered tools and integrated communication systems. The platform operates as a mobile and web application serving as a global fashion marketplace, facilitating connections between users and bespoke tailors and designers worldwide. The system architecture is designed to be scalable globally with multi-currency support and localization readiness, enabling seamless cross-border transactions and communications. The platform integrates multiple technical components including user authentication systems, designer portfolio management, artificial intelligence-driven recommendation engines, real-time communication protocols, and secure payment processing infrastructure.

The technical architecture incorporates performance specifications that ensure the system operates with load times under 2 seconds for screens and maintains 99.5% uptime SLA. The platform includes WCAG 2.1 AA accessibility compliance and GDPR/CCPA compliance features to accommodate diverse user populations and regulatory requirements across different jurisdictions. Security features encompass PCI DSS secure payment processing with encrypted data storage and transmission protocols, protecting sensitive user information and financial transactions throughout the platform ecosystem. The infrastructure supports real-time data processing for artificial intelligence algorithms, user interactions, and communication systems while maintaining data integrity and user privacy standards.

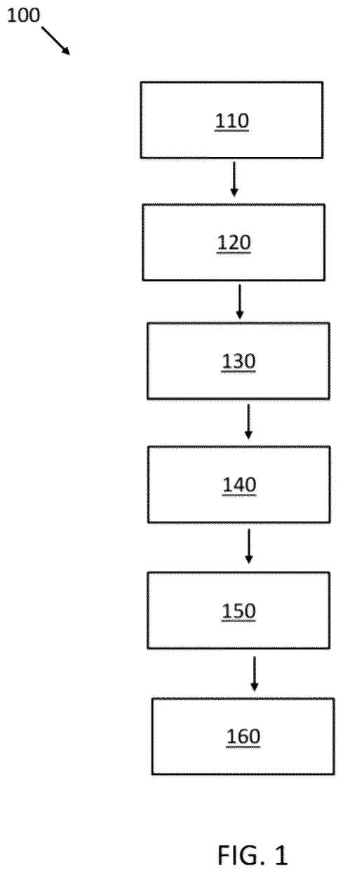

Referring to FIG. 1, a method 100 provides onboarding functionality for first-time users accessing the platform. The method 100 begins with a step 110 where a new user signs up or logs in for the first time to the digital fashion marketplace platform. A step 120 presents a welcome screen that appears offering a tour option, wherein the onboarding method includes a skip option allowing users to bypass the guided tour if desired. A step 130 implements the tour functionality that highlights various features including the home feed, designer browsing, custom order functionality, and artificial intelligence tools. A step 140 provides tooltips and overlays that deliver guidance to users navigating the platform interface. A step 150 displays a confirmation screen indicating completion of the tour process. A step 160 enables users to revisit the tour later under Profile→App Tour, providing ongoing access to onboarding assistance.

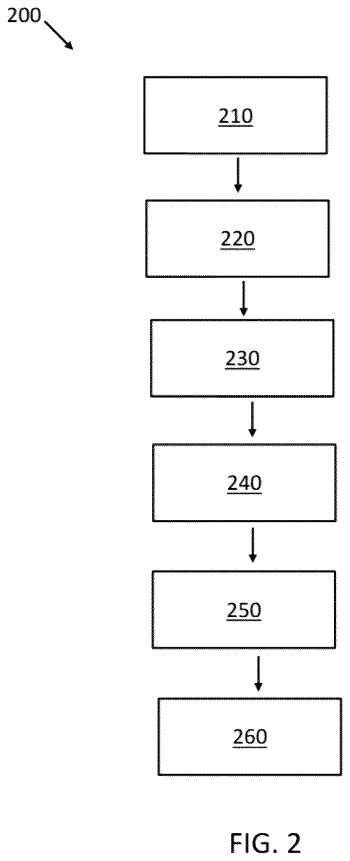

With reference to FIG. 2, a method 200 facilitates discovering designers and styles within the marketplace platform. The method 200 initiates at a step 210 where a user enters the Marketplace feed interface. A step 220 enables browsing functionality through scrolling mechanisms that present curated designs, trending styles, and featured designers. The designer discovery method includes filtering by location, fabric type, event type, and designer rating through a step 230 where the user applies various filter criteria. A step 240 allows users to access designer profiles by clicking to view portfolio content, biographical information, and review data. A step 250 implements saving functionality where users can tap “Save” to add designers or designs to Favorites or Wishlist collections. A step 260 provides accessibility to saved items under My Favorites, creating persistent storage for user preferences and selections.

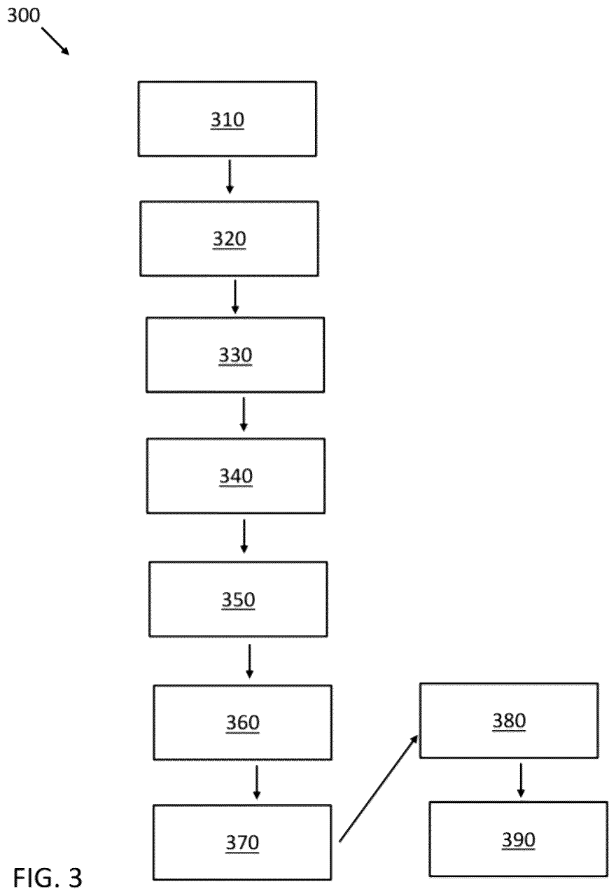

As shown in FIG. 3, a process 300 manages revised custom orders through flexible interaction pathways. The process 300 commences at a step 310 where a user selects a designer and activates Request Custom Design functionality. A step 320 presents a prompt that offers options to users, wherein the custom order method provides two distinct options: scheduling consultation or sending direct message to designer. A step 330 processes the user's selection to determine whether consultation scheduling or direct messaging pathways are activated. A step 340 enables message transmission functionality where users can communicate about fabric ideas or references with designers. A step 350 implements fabric selection mechanisms from available options including designer catalogs, marketplace inventory, or user-uploaded materials. A step 360 facilitates measurement provision through various input methods. A step 370 processes designer responses containing quotations and estimated timeline information. A step 380 handles user review and acceptance processes, proceeding to secure payment systems. A step 390 implements order tracking functionality under My Orders interface, providing status updates through notification systems.

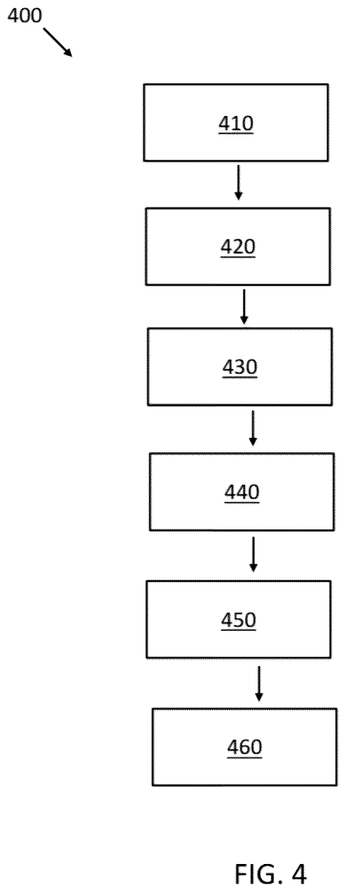

Referring to FIG. 4, a method 400 provides artificial intelligence-powered body measurement capabilities. The method 400 begins at a step 410 where users receive prompts to add measurements during order creation processes. A step 420 enables image capture functionality through full-body photo uploads or live camera capture mechanisms. A step 430 implements artificial intelligence analysis that generates measurements including chest, waist, hips, and other dimensional data. A step 440 displays measurement results for user confirmation with manual editing options available. The AI body measurement method includes a privacy notice stating photos are processed securely and never stored, implemented through a step 460 that communicates data handling protocols. A step 450 provides measurement storage functionality in My Measurements for reuse in future order processes.

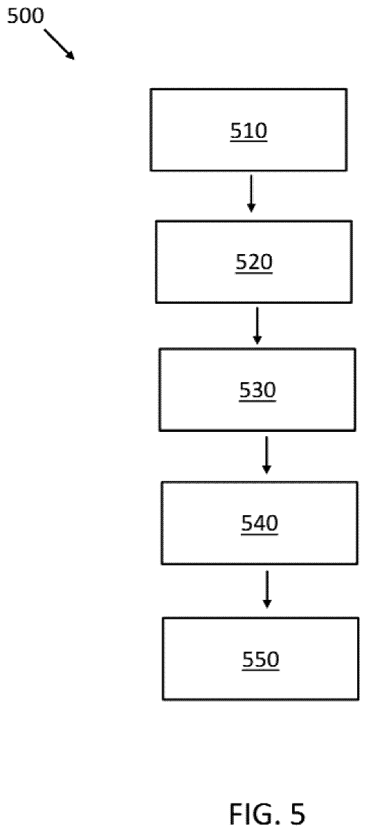

As illustrated in FIG. 5, a method 500 manages real-time chat and consultation functionality between users and designers. The method 500 initiates at a step 510 where users activate chat with designer or schedule call options. A step 520 opens messaging interfaces for chat functionality where text, images, and files can be shared between parties. A step 530 processes consultation scheduling where users select available time slots, designers provide acceptance, and confirmation messages are transmitted. A step 540 conducts video call sessions between users and designers. A step 550 maintains notes and file attachments within order threads following consultation completion, preserving communication history and reference materials.

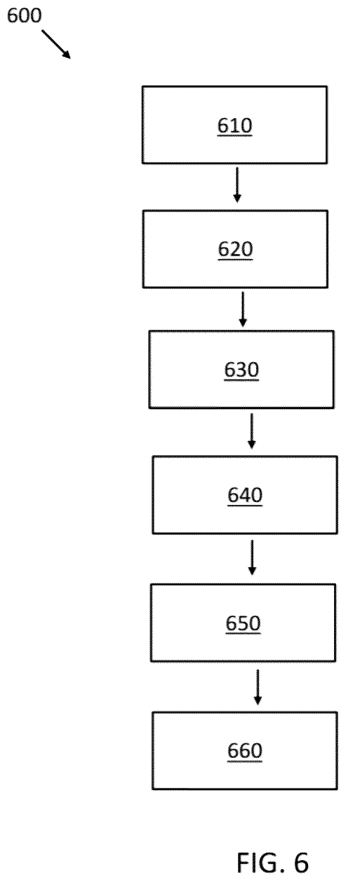

As shown in FIG. 6, a verification process 600 establishes designer authentication through document validation systems. The verification process 600 commences at a step 610 where designers navigate to Profile and Verification interfaces following registration completion. The verification process uses Prembly API for document processing and validation, implemented through a step 630 that processes submitted documentation through external validation services. A step 620 enables document upload functionality where designers submit required materials, wherein the verification process requires specific documents including ID, business docs, and CAC docs. A step 640 processes approval determinations and adds Verified Badge elements to designer profiles upon successful validation. A step 650 restricts custom order acceptance capabilities to verified designers exclusively. A step 660 displays “Verified Designer” badge elements to customers during profile browsing activities, establishing trust indicators throughout the marketplace interface.

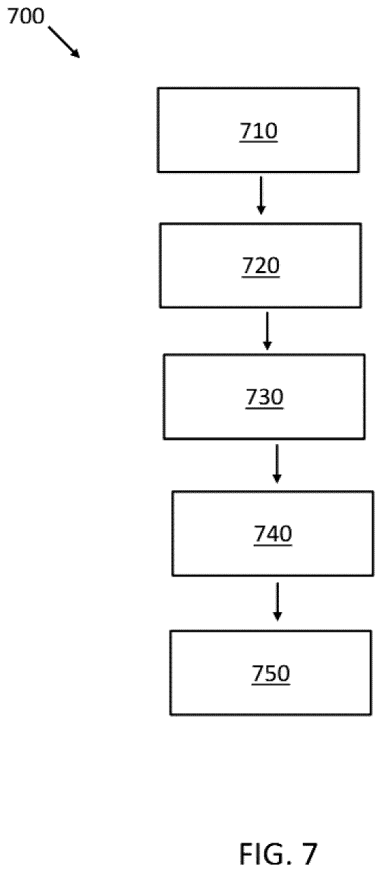

Referring to FIG. 7, a method 700 implements artificial intelligence chatbot assistance functionality across the platform ecosystem. The method 700 begins at a step 710 where users activate “Help” options or initiate chat queries through interface elements. A step 720 generates chatbot greeting messages and presents quick option selections to users. A step 730 processes user queries including specific requests for trending fashion items or marketplace information. A step 740 delivers chatbot responses containing recommendations and relevant link references to designer profiles or product listings. The AI chatbot method includes escalation to human support specialists for complex queries through a step 750 that transfers conversations to support personnel when automated responses prove insufficient. The chatbot system integrates with the broader platform architecture to access real-time inventory data, designer availability information, and user preference histories.

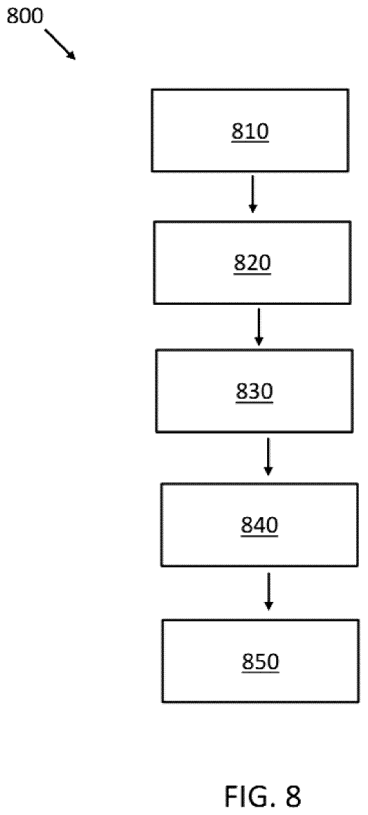

With reference to FIG. 8, a method 800 operates an artificial intelligence recommendation engine that personalizes user experiences through data analysis. The method 800 initiates at a step 810 where the system collects browsing patterns, search histories, save actions, and purchase data from user interactions. A step 820 generates recommendation displays under “For You” sections on home feed interfaces and product page locations. A step 830 delivers suggestions encompassing designers, fabrics, and designs tailored to individual user preferences and behavioral patterns. A step 840 provides contextual suggestions based on user interaction patterns, such as recommending wedding fabric vendors and highly-rated bridal designers when users save wedding gown items. The recommendation method updates dynamically as users interact more with the platform through a step 850 that continuously refines suggestion algorithms based on ongoing user engagement data.

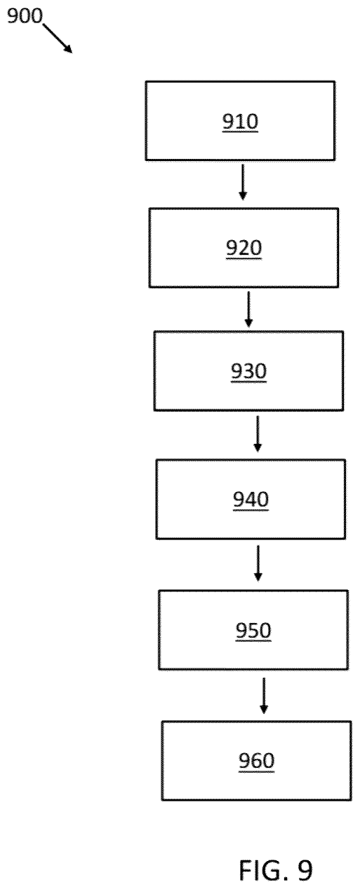

As illustrated in FIG. 9, a method 900 manages fabric and product sales functionality within the marketplace ecosystem. The method 900 commences at a step 910 where users access fabric and products marketplace interfaces. A step 920 enables browsing functionality for available inventory items, wherein the fabric sales method includes ready-to-wear clothing and accessories in addition to fabrics. A step 930 displays product detail pages containing price information, stock levels, review data, and shipping specifications. A step 940 implements cart functionality and checkout processes for selected items. A step 950 processes payment completion through integrated gateway systems that connect with the platform's secure payment infrastructure. A step 960 provides delivery tracking capabilities under My Orders interfaces, enabling users to monitor shipment progress and delivery status updates.

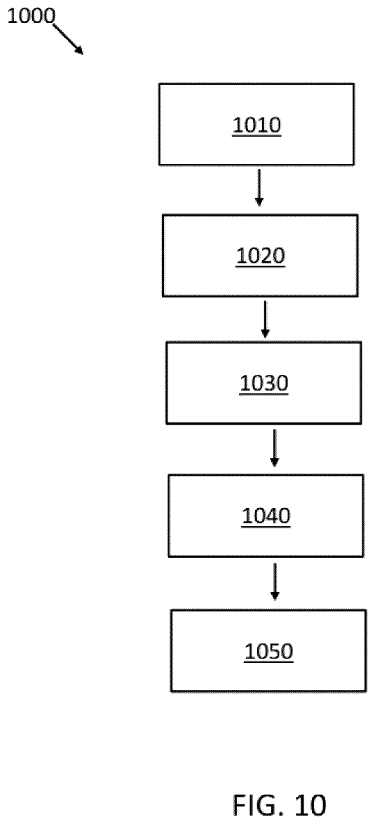

Referring to FIG. 10, a method 1000 implements review and rating systems that establish transparency and credibility within the marketplace platform. The method 1000 begins at a step 1010 where users receive notification prompts following order completion or delivery events, requesting designer and experience ratings. A step 1020 enables rating selection and review composition functionality through user interface elements. The review method restricts review submission to verified buyers only to prevent fake ratings through a step 1030 that validates purchase completion before enabling review submission capabilities. A step 1040 displays review content on designer profiles and product listing pages throughout the marketplace interface. The review method allows designers to reply publicly to reviews for credibility building through a step 1050 that enables designer response functionality, fostering transparent communication between service providers and customers.

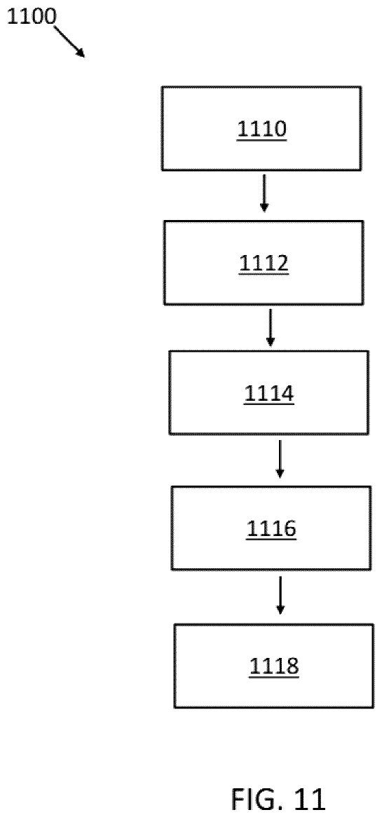

As shown in FIG. 11, a method 1100 manages abandoned browsing scenarios through targeted notification systems. The method 1100 initiates at a step 1110 where users browse designer profiles or product pages without completing purchase actions. A step 1112 tracks user exit behavior when users leave interfaces without booking or cart additions. A step 1114 implements waiting periods before notification activation, allowing appropriate time intervals between user actions and system responses. A step 1116 generates contextual pop-up messages or push notifications designed to re-engage users with previously viewed content. The notification process includes abandoned browsing reminders with a maximum of two reminders per design to avoid spamming through a step 1118 that limits notification frequency to prevent user experience degradation.

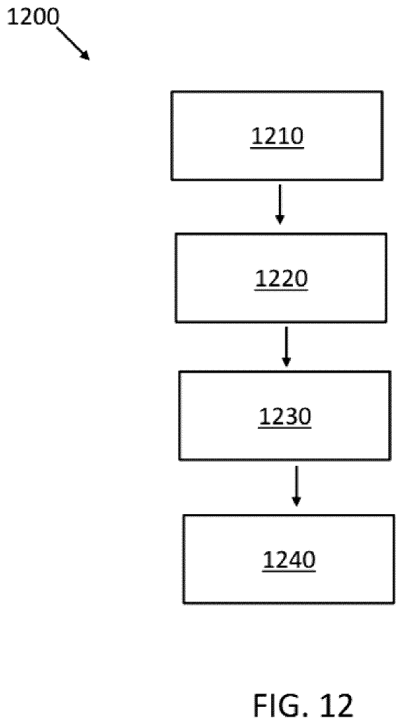

With reference to FIG. 12, a process 1200 handles incomplete consultation booking scenarios through contextual reminder systems. The process 1200 begins at a step 1210 where users initiate consultation bookings with designers through scheduling interfaces. A step 1220 monitors completion status for measurement submissions and payment processing activities. A step 1230 triggers reminder notifications when users fail to complete required booking steps, generating messages specific to incomplete actions such as measurement sharing or payment completion. The notification process includes incomplete consultation booking reminders that are contextual to the specific stage of the flow through a step 1240 that customizes notification content based on user progress within booking workflows.

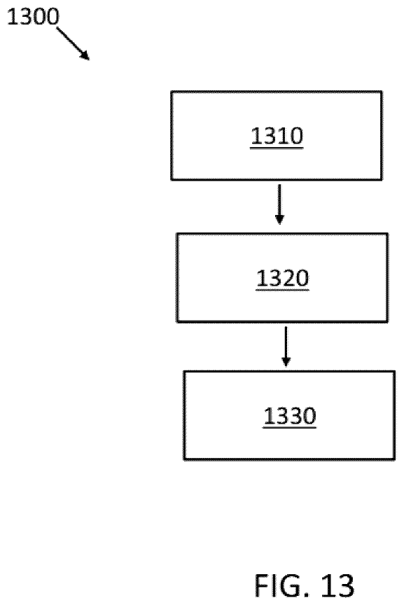

As illustrated in FIG. 13, a process 1300 manages order delivery progress updates through milestone-based notification systems. The process 1300 commences at a step 1310 where designers update order progress following confirmation, including stages such as cutting completion and fitting progress. A step 1320 delivers push notifications or in-app messages at each milestone, providing users with real-time updates on custom order advancement. A step 1330 generates completion prompts when delivery finishes, requesting user ratings and review submissions for completed transactions. The notification system integrates with designer workflow management tools to automatically trigger status updates based on production milestone achievements, ensuring consistent communication throughout the custom order fulfillment process.

The comprehensive notification architecture encompasses multiple engagement strategies that operate across different user interaction scenarios. The notification process includes wish list reminders for saved items that users haven't acted upon after a few days, generating targeted messages that reference specific saved designers, fabrics, or designs to encourage conversion from passive interest to active engagement. The notification process includes expiring offers and limited stock alerts to create urgency through time-sensitive messaging that informs users about promotional deadlines or inventory limitations. The notification process includes inactive user re-engagement for users who haven't opened the app in 7-14 days, delivering personalized messages highlighting new designer additions, trending styles, or platform updates to encourage return visits. The notification process includes seasonal and event-based nudges around cultural events like Eid, Christmas, and fashion weeks, providing timely reminders that align with cultural celebrations and fashion industry events to drive relevant engagement and purchase decisions.

The method 100 establishes a comprehensive user onboarding framework that guides first-time users through platform familiarization while accommodating varying user preferences for guided assistance. The onboarding system operates through sequential interface presentations that introduce platform functionality without imposing mandatory participation requirements. The step 110 initiates the onboarding sequence when new users complete registration processes or authenticate for initial platform access, triggering automated detection systems that identify first-time user status through account creation timestamps and login history analysis. The platform architecture maintains user state information throughout the onboarding process, enabling seamless transitions between guided tour elements and standard platform navigation interfaces.

The step 120 generates welcome screen presentations that offer tour participation options through interactive interface elements, providing users with clear choices regarding guided assistance preferences. The onboarding method includes a skip option allowing users to bypass the guided tour if desired, implemented through prominent skip button placement that enables immediate transition to standard platform interfaces without completing tour sequences. The welcome screen architecture incorporates visual design elements that communicate tour benefits while respecting user autonomy in navigation choices. The skip functionality preserves user preferences through session management systems that prevent repeated tour prompts during subsequent login sessions, while maintaining accessibility to guided assistance through alternative access pathways.

With continued reference to FIG. 1, the step 130 delivers comprehensive feature highlighting that encompasses home feed navigation, designer browsing mechanisms, custom order functionality, and artificial intelligence tool integration. The tour presentation system utilizes progressive disclosure techniques that introduce platform capabilities through structured information delivery, preventing cognitive overload while ensuring comprehensive feature coverage. The highlighting mechanisms incorporate visual emphasis techniques including interface element outlining, color contrast adjustments, and animation sequences that direct user attention to specific functionality areas. The tour content adapts to user interaction patterns, providing additional detail for areas where users demonstrate extended engagement while maintaining streamlined presentations for rapidly navigated sections.

The step 140 implements guidance delivery through tooltip systems and overlay presentations that provide contextual information during user navigation activities. The tooltip architecture generates dynamic content based on user cursor positioning and interface element interaction, delivering just-in-time information that supports learning without interrupting workflow continuity. The overlay systems create temporary interface modifications that highlight specific functionality while maintaining underlying platform structure visibility, enabling users to understand feature locations within standard interface contexts. The guidance mechanisms incorporate accessibility features including screen reader compatibility, keyboard navigation support, and adjustable text sizing to accommodate diverse user capabilities and preferences.

The step 150 presents completion confirmation through dedicated screen interfaces that acknowledge successful tour participation and provide transition pathways to standard platform usage. The confirmation system incorporates achievement recognition elements that reinforce positive user experiences while establishing clear boundaries between guided assistance and independent platform exploration. The completion screens provide summary information regarding covered features and offer quick access links to frequently used functionality areas, supporting immediate platform engagement following tour completion. The confirmation architecture maintains session continuity by preserving user preferences and interface customizations established during tour participation, ensuring seamless transitions to productive platform usage.

As further shown in FIG. 1, the step 160 establishes ongoing tour accessibility through profile-based navigation pathways that enable users to revisit guided assistance at any time following initial platform engagement. The onboarding method allows users to revisit the tour later under Profile→App Tour, implemented through persistent menu options that maintain tour availability regardless of user experience level or platform familiarity. The revisit functionality preserves tour content integrity while adapting presentation sequences to accommodate existing user knowledge and platform customizations. The profile integration architecture ensures tour accessibility across device platforms and login sessions, maintaining consistent guided assistance availability through cloud-based preference synchronization and cross-platform interface standardization.

The method 200 establishes a comprehensive designer and style discovery framework that enables users to navigate marketplace content through structured browsing mechanisms and advanced filtering capabilities. The discovery system operates through sequential interface interactions that guide users from initial marketplace entry through designer selection and preference storage activities. The step 210 activates marketplace feed interfaces when users select discovery options from primary navigation elements, triggering content loading sequences that populate interface areas with curated designer portfolios, trending style collections, and featured design presentations. The marketplace feed architecture incorporates dynamic content management systems that refresh designer listings based on availability status, portfolio updates, and performance metrics while maintaining consistent interface responsiveness across different device platforms and network conditions.

The step 220 implements browsing functionality through scrolling mechanisms that present curated designs, trending styles, and featured designers within organized interface layouts. The browsing system utilizes infinite scroll architecture that loads additional content as users approach interface boundaries, preventing pagination interruptions while maintaining smooth navigation experiences. The curated design presentations incorporate visual hierarchy principles that emphasize high-quality portfolio images, designer identification elements, and style category indicators through consistent layout structures. The trending style algorithms analyze user interaction patterns, search frequencies, and engagement metrics to surface popular design categories and emerging fashion trends within marketplace feeds. Featured designer selections operate through algorithmic ranking systems that consider verification status, review ratings, order completion rates, and portfolio quality assessments to promote established marketplace participants.

With continued reference to FIG. 2, the step 230 activates multi-criteria filtering systems that enable users to refine marketplace content based on specific search parameters and preference selections. The designer discovery method includes filtering by location, fabric type, event type, and designer rating through comprehensive filter interface panels that accommodate multiple simultaneous selection criteria. The location filtering mechanisms incorporate geographic search capabilities that enable users to discover designers within specific regions, countries, or proximity ranges based on shipping preferences or cultural style interests. Fabric type filtering systems categorize designers based on material specializations including traditional textiles, contemporary fabrics, sustainable materials, and luxury fabric options, enabling users to locate specialists in specific material categories. Event type filtering functionality organizes designers according to occasion specializations such as wedding attire, formal wear, casual clothing, cultural garments, and seasonal collections, facilitating targeted discovery for specific wardrobe requirements.

The designer rating filtering component integrates with the platform's review and rating infrastructure to enable users to discover designers based on customer satisfaction metrics and service quality indicators. The rating filter interface presents sliding scale controls that allow users to specify minimum rating thresholds, ensuring discovery results include only designers meeting specified quality standards. The filtering system architecture maintains real-time synchronization with designer profile updates, inventory changes, and rating modifications to ensure filter results reflect current marketplace conditions. The multi-criteria filtering engine processes complex query combinations through optimized database indexing and caching mechanisms that deliver rapid result updates without compromising interface responsiveness or user experience quality.

The step 240 enables detailed designer profile access through clickable interface elements that transition users from marketplace browsing to comprehensive designer information displays. The profile interface architecture presents portfolio content through organized gallery layouts that showcase designer work samples, style specializations, and completed project examples through high-resolution image presentations. Biographical information sections provide designer background details including experience levels, training credentials, cultural specializations, and design philosophy statements that help users evaluate compatibility with personal style preferences. The review data integration displays customer feedback, rating distributions, and testimonial content through structured presentation formats that enable rapid assessment of designer reputation and service quality indicators.

As further shown in FIG. 2, the step 250 implements saving functionality through interactive interface elements that enable users to preserve designer and design selections for future reference and comparison activities. The save mechanism operates through single-tap activation that adds selected designers or specific designs to personalized collection areas without interrupting browsing workflows or requiring navigation away from discovery interfaces. The system architecture maintains separate storage categories for designer profiles and individual design pieces, enabling users to organize saved content according to different selection criteria and reference purposes. The saving functionality integrates with user account systems to ensure saved selections persist across device platforms and login sessions through cloud-based synchronization mechanisms that maintain collection integrity and accessibility.

The step 260 provides persistent access to saved content through My Favorites interface sections that organize preserved selections into browsable collection formats. The favorites architecture implements categorization systems that enable users to organize saved designers and designs according to custom labels, event types, or preference hierarchies through user-defined organizational structures. The collection interface incorporates search and filtering capabilities that enable users to locate specific saved items within larger collections through text-based queries or attribute-based filtering mechanisms. The favorites system maintains historical tracking of saved items including save dates, interaction frequencies, and subsequent actions taken, enabling users to prioritize collections based on engagement patterns and decision-making timelines. The persistent storage architecture ensures saved collections remain accessible across extended time periods while providing options for collection management including item removal, category reorganization, and sharing capabilities with other platform users or external contacts.

The process 300 establishes a comprehensive custom order workflow system that accommodates diverse user communication preferences through flexible interaction pathways and streamlined order management capabilities. The custom order architecture operates through sequential processing stages that guide users from initial designer selection through final order completion while maintaining adaptability to different communication styles and ordering preferences. The process 300 integrates with the broader platform ecosystem to access designer availability information, fabric inventory systems, measurement storage capabilities, and payment processing infrastructure through interconnected application programming interfaces and data synchronization mechanisms. The workflow system incorporates real-time status tracking, automated notification delivery, and progress monitoring capabilities that ensure transparent communication throughout the custom order lifecycle.

Referring to FIG. 3, the step 310 initiates the custom order sequence when users select specific designers from marketplace interfaces and activate Request Custom Design functionality through interactive interface elements. The designer selection mechanism operates through clickable profile elements that transition users from browsing activities to order initiation workflows while preserving selected designer information and portfolio context within order processing systems. The Request Custom Design activation triggers system processes that verify designer availability status, load designer-specific ordering parameters, and initialize order tracking mechanisms that monitor workflow progression through subsequent processing stages. The step 310 incorporates validation systems that confirm designer verification status and service availability before enabling order progression, ensuring users engage with authenticated service providers capable of fulfilling custom design requests.

The step 320 presents communication option selection through structured prompt interfaces that offer users distinct pathways for designer interaction and order specification activities. The custom order method provides two distinct options: scheduling consultation or sending direct message to designer, implemented through clearly differentiated interface elements that communicate the characteristics and benefits of each communication approach. The consultation scheduling option provides structured interaction frameworks that enable users to reserve dedicated time periods for detailed design discussions, measurement consultations, and collaborative design development activities through video conferencing or voice communication systems. The direct messaging option enables immediate communication initiation through text-based messaging interfaces that support file sharing, image transmission, and asynchronous communication patterns that accommodate different time zones and scheduling constraints.

With continued reference to FIG. 3, the step 330 processes user communication preference selections and activates corresponding interaction systems based on chosen communication pathways. The consultation pathway activation triggers scheduling interface presentations that display designer availability calendars, time slot selection mechanisms, and booking confirmation systems that coordinate meeting arrangements between users and designers. The direct messaging pathway activation opens real-time chat interfaces that enable immediate message composition and transmission while providing access to file upload capabilities, image sharing functions, and conversation history preservation systems. The step 330 incorporates pathway-specific interface customizations that optimize user experiences for selected communication methods while maintaining consistent access to order progression tools and reference materials across different interaction modes.

The step 340 enables comprehensive message transmission functionality that supports detailed communication about fabric preferences, design references, style inspirations, and project specifications between users and designers. The messaging system architecture incorporates rich media support that enables users to share inspiration images, fabric samples, style references, and design sketches through integrated file upload mechanisms and image capture tools. The communication interface provides text formatting capabilities, emoji support, and message organization features that enhance expression clarity and conversation management throughout extended design collaboration periods. The step 340 integrates with designer notification systems to ensure timely message delivery and response coordination while maintaining conversation threading that preserves communication context and reference materials within order-specific discussion channels.

As further shown in FIG. 3, the step 350 implements fabric selection mechanisms that provide users with comprehensive material options through designer catalogs, marketplace inventory systems, and user-provided fabric alternatives. The fabric selection interface presents organized catalog displays that showcase available materials through high-resolution imagery, detailed specifications, pricing information, and availability status indicators that enable informed material decisions. The marketplace inventory integration expands fabric options beyond individual designer collections to include platform-wide material suppliers, specialty fabric vendors, and cultural textile providers that offer diverse material choices for custom design projects. The user-provided fabric option enables customers to supply personal materials through shipping coordination systems and material specification documentation that ensures designer compatibility with customer-provided textiles.

The step 360 facilitates measurement provision through multiple input methodologies that accommodate different user preferences and accuracy requirements for custom garment construction. The measurement collection system integrates with artificial intelligence-powered body measurement tools that analyze user-provided photographs to generate dimensional data while providing manual entry alternatives for users preferring traditional measurement approaches. The measurement interface incorporates guided measurement tutorials, sizing reference charts, and measurement validation systems that help users provide accurate dimensional information for custom garment construction. The step 360 connects with measurement storage systems that preserve user dimensional data for future order processing while implementing privacy protection measures that secure personal measurement information through encrypted storage and access control mechanisms.

With continued reference to FIG. 3, the step 370 processes designer response generation that delivers comprehensive quotations, project timelines, and service specifications based on user requirements and design parameters. The quotation system incorporates dynamic pricing calculations that consider fabric costs, design complexity, construction time requirements, and shipping considerations to generate accurate project cost estimates. The timeline estimation algorithms analyze designer workload, project complexity factors, and production scheduling to provide realistic completion timeframes that account for design development, construction phases, and quality assurance processes. The step 370 enables designers to include detailed project specifications, construction methodologies, and service inclusions within response packages that help users understand project scope and deliverable expectations.

The step 380 manages user review and acceptance processes through structured evaluation interfaces that present quotation details, timeline information, and project specifications for customer consideration and approval. The review interface organizes designer responses into clearly formatted presentations that enable users to evaluate pricing components, timeline feasibility, and service inclusions through comparative analysis tools and decision support features. The acceptance mechanism provides clear approval pathways that transition users from evaluation activities to payment processing while preserving order specifications and designer commitments within binding agreement frameworks. The step 380 incorporates modification request capabilities that enable users to negotiate pricing adjustments, timeline modifications, or specification changes through structured communication channels that maintain order integrity while accommodating reasonable customization requests.

As further shown in FIG. 3, the step 390 implements comprehensive order tracking functionality through My Orders interface systems that provide real-time status monitoring, progress updates, and communication access throughout custom order fulfillment processes. The tracking system architecture maintains detailed order histories that document specification approvals, payment confirmations, production milestones, and delivery coordination activities through chronological status displays and progress visualization tools. The notification integration delivers automated updates through push notifications, email communications, and in-application messaging systems that inform users about production progress, milestone achievements, and delivery scheduling without requiring active order monitoring. The step 390 provides persistent access to order-related communications, specification documents, and designer contact information through organized interface sections that support ongoing collaboration and issue resolution throughout extended custom order fulfillment periods.

Referring to FIG. 4, the method 400 establishes a comprehensive artificial intelligence-powered body measurement system that enables accurate dimensional data collection through automated image analysis and user-friendly interface interactions. The method 400 operates through sequential processing stages that guide users from measurement initiation through data validation and storage activities while maintaining privacy protection standards and measurement accuracy requirements. The artificial intelligence measurement system integrates computer vision algorithms, machine learning models, and dimensional analysis capabilities that process user-provided imagery to generate precise body measurements for custom garment construction. The method 400 incorporates multiple input pathways that accommodate different user preferences and technical capabilities while ensuring measurement accuracy through validation mechanisms and manual correction options.

The step 410 initiates the measurement collection process when users receive prompts to add measurements during order creation workflows within the custom design system. The measurement prompt activation occurs at strategic points within order processing sequences where dimensional data becomes necessary for design specification and quotation generation activities. The step 410 integrates with order management systems to determine measurement requirements based on garment types, design specifications, and designer preferences while providing contextual information about measurement purposes and accuracy expectations. The prompt interface incorporates educational elements that explain measurement collection processes, accuracy considerations, and data usage policies to ensure informed user participation in dimensional data collection activities.

With continued reference to FIG. 4, the step 420 enables comprehensive image capture functionality through full-body photo upload mechanisms and live camera capture systems that accommodate different user technical environments and privacy preferences. The photo upload functionality supports multiple image formats and resolution specifications while implementing file size optimization algorithms that maintain image quality while ensuring efficient data transmission and processing performance. The live camera capture system activates device camera interfaces that provide real-time image preview capabilities, positioning guidance overlays, and capture confirmation mechanisms that help users generate suitable imagery for artificial intelligence analysis. The step 420 incorporates lighting assessment algorithms that evaluate image quality parameters and provide feedback regarding optimal capture conditions to ensure artificial intelligence processing accuracy.

The step 430 implements sophisticated artificial intelligence analysis systems that process captured imagery to generate comprehensive body measurements including chest, waist, hips, and additional dimensional data required for custom garment construction. The artificial intelligence processing architecture utilizes computer vision algorithms that identify anatomical landmarks, calculate proportional relationships, and generate dimensional measurements through advanced image analysis techniques. The measurement generation process incorporates machine learning models trained on diverse body types, clothing configurations, and photographic conditions to ensure accurate dimensional calculations across varied user populations and image capture scenarios. The step 430 processes multiple measurement points simultaneously while implementing error detection algorithms that identify potential measurement inconsistencies and flag results requiring additional validation or manual review.

As further shown in FIG. 4, the step 440 presents measurement results through organized display interfaces that enable user confirmation and provide manual editing capabilities for dimensional data refinement and accuracy verification. The results presentation system organizes generated measurements into categorized displays that group related dimensional data while providing visual representations of measurement locations and calculation methodologies. The manual editing functionality enables users to modify individual measurement values through input fields that incorporate validation ranges and consistency checking algorithms to prevent unrealistic dimensional data entry. The step 440 provides comparison tools that enable users to evaluate artificial intelligence-generated measurements against personal knowledge or existing measurement records while maintaining flexibility for user-directed corrections and adjustments.

The step 450 establishes measurement storage functionality within My Measurements interface systems that preserve dimensional data for reuse in future order processing activities while implementing user account integration and cross-device synchronization capabilities. The storage architecture maintains measurement histories that document collection dates, data sources, and modification records while providing organizational tools that enable users to manage multiple measurement sets for different garment categories or time periods. The reuse functionality streamlines subsequent order processes by automatically populating measurement fields with stored dimensional data while providing options for measurement updates and accuracy verification. The step 450 incorporates data synchronization mechanisms that ensure measurement availability across different device platforms and login sessions through cloud-based storage systems that maintain data integrity and accessibility.

With continued reference to FIG. 4, the step 460 implements comprehensive privacy protection measures through user notification systems that communicate data handling protocols and security practices for image processing and measurement storage activities. The AI body measurement method includes a privacy notice stating photos are processed securely and never stored, implemented through prominent notification displays that inform users about image processing procedures and data retention policies. The privacy notice architecture provides detailed explanations of artificial intelligence processing methodologies, data transmission security measures, and storage limitation policies that ensure user understanding of privacy protection practices. The step 460 incorporates consent mechanisms that enable users to acknowledge privacy policies and data handling procedures before proceeding with image capture and analysis activities while maintaining compliance with data protection regulations and user privacy expectations.

The artificial intelligence measurement system architecture incorporates advanced security protocols that protect user imagery during processing activities while ensuring dimensional data accuracy through sophisticated analysis algorithms and validation mechanisms. The image processing pipeline implements encryption protocols that secure data transmission between user devices and processing servers while maintaining processing efficiency and measurement accuracy standards. The system architecture utilizes distributed processing capabilities that enable rapid image analysis without compromising security measures or user privacy protection requirements. The measurement validation algorithms incorporate statistical analysis techniques that evaluate dimensional consistency and identify potential measurement errors through comparative analysis with population data and anatomical proportion standards, ensuring reliable measurement generation for custom garment construction activities.

Referring to FIG. 5, the method 500 establishes a comprehensive real-time communication framework that facilitates seamless interaction between users and designers through integrated messaging and video consultation capabilities. The method 500 operates through dual communication pathways that accommodate different user preferences for designer interaction while maintaining consistent access to file sharing, conversation history, and order coordination functionality throughout the communication process. The real-time communication architecture integrates with the broader platform ecosystem to synchronize conversation data across multiple device platforms while preserving message threading and attachment accessibility through cloud-based storage systems. The method 500 incorporates notification systems that alert participants about new messages, consultation scheduling updates, and file sharing activities to ensure timely communication coordination between users and designers across different time zones and availability schedules.

The step 510 initiates communication workflows when users activate chat with designer or schedule call options through interactive interface elements within designer profiles or order management systems. The communication activation mechanism presents users with clearly differentiated options that communicate the characteristics and benefits of text-based messaging versus structured video consultation approaches. The chat activation pathway opens immediate messaging interfaces that enable real-time text communication without scheduling requirements or time coordination constraints between users and designers. The schedule call activation pathway transitions users to consultation booking interfaces that display designer availability calendars and time slot selection mechanisms for coordinated video communication sessions. The step 510 incorporates user preference detection systems that remember previous communication choices and provide streamlined access to preferred interaction methods during subsequent designer communications.

With continued reference to FIG. 5, the step 520 implements comprehensive messaging interface functionality that supports rich media communication through text, image, and file sharing capabilities within organized conversation displays. The messaging screen architecture presents conversation histories through chronological message threading that maintains context continuity while providing clear visual distinctions between user and designer communications. The text communication functionality incorporates real-time typing indicators, message delivery confirmations, and read receipt systems that provide communication status awareness for both conversation participants. The image sharing capabilities enable users to transmit inspiration photos, fabric samples, design references, and progress documentation through integrated camera access and photo library selection mechanisms. The file sharing functionality supports document transmission including measurement specifications, design sketches, contract documents, and reference materials through secure upload systems that maintain file integrity and accessibility throughout order processing workflows.

The step 530 manages consultation scheduling processes through integrated calendar systems that coordinate time slot selection, designer acceptance workflows, and confirmation delivery mechanisms for structured video communication sessions. The time slot selection interface presents designer availability through visual calendar displays that show available appointment windows while accommodating different time zone presentations based on user location settings. The scheduling system incorporates buffer time calculations that account for consultation preparation, technical setup requirements, and follow-up documentation activities to ensure adequate time allocation for comprehensive design discussions. The designer acceptance workflow enables service providers to confirm or modify proposed consultation times while providing alternative scheduling suggestions when requested time slots conflict with existing commitments or availability constraints. The confirmation delivery system generates automated notifications that provide consultation details, connection instructions, and preparation guidelines to both users and designers through email communications and in-application messaging systems.

As further shown in FIG. 5, the step 540 conducts video call sessions through integrated video conferencing systems that provide high-quality audio and visual communication capabilities for detailed design consultations and collaborative project development activities. The video call architecture utilizes adaptive streaming technologies that optimize connection quality based on network conditions while maintaining consistent audio clarity and visual resolution throughout consultation sessions. The video interface incorporates screen sharing capabilities that enable designers to present portfolio examples, demonstrate design techniques, and review project specifications through shared visual presentations during consultation sessions. The call management functionality provides recording options, session duration tracking, and connection quality monitoring to ensure productive consultation experiences while maintaining technical performance standards. The step 540 integrates with order management systems to automatically associate consultation sessions with specific custom order projects while preserving access to relevant project specifications and communication histories during video discussions.

The step 550 establishes persistent information preservation systems that maintain notes, file attachments, and conversation records within order-specific threads following consultation completion and ongoing messaging activities. The information preservation architecture creates comprehensive communication archives that document design discussions, specification agreements, modification requests, and project milestone communications through organized storage systems that remain accessible throughout extended order fulfillment periods. The note attachment functionality enables both users and designers to add written summaries, action item lists, and reference documentation to consultation records while maintaining clear attribution and timestamp information for accountability and progress tracking purposes. The file attachment preservation ensures that shared images, documents, and reference materials remain accessible through order completion while implementing version control systems that track document modifications and update histories. The step 550 provides search functionality within conversation archives that enables participants to locate specific discussions, agreements, or shared materials through text-based queries and date range filtering mechanisms, supporting efficient information retrieval during extended project collaboration periods.

Referring to FIG. 6, the verification process 600 establishes a comprehensive designer authentication framework that validates service provider credentials through systematic document collection, external API processing, and trust indicator implementation across the marketplace platform. The verification process 600 operates through sequential validation stages that guide designers from initial document submission through final badge assignment while maintaining integration with external validation services and platform trust systems. The authentication architecture incorporates third-party API integration capabilities that enable automated document verification through established identity validation services while preserving document security and processing efficiency throughout the verification workflow. The verification process 600 connects with designer profile management systems to display trust indicators and restrict service access based on verification completion status, ensuring marketplace participants engage with authenticated service providers.

The step 610 initiates the verification workflow when designers navigate to Profile and Verification interfaces following registration completion within the platform ecosystem. The verification initiation mechanism presents designers with completion status indicators that communicate verification progress and highlight remaining documentation requirements through visual progress displays and notification systems. The Profile navigation pathway provides dedicated verification sections that organize document upload interfaces, status tracking displays, and completion guidance information within designer account management areas. The step 610 incorporates completion percentage calculations that inform designers about verification progress while providing clear pathways to address outstanding documentation requirements and advance through verification stages.

With continued reference to FIG. 6, the step 620 enables comprehensive document upload functionality that accommodates multiple file formats and implements secure transmission protocols for sensitive identification and business documentation. The verification process requires specific documents including ID, business docs, and CAC docs, implemented through structured upload interfaces that provide clear documentation requirements and format specifications for each document category. The identification document collection encompasses government-issued identification cards, passports, driver's licenses, and other official identity verification materials that establish designer identity and legal status within operating jurisdictions. The business documentation requirements include business registration certificates, tax identification numbers, professional licenses, and commercial operation permits that validate designer business legitimacy and operational compliance. The CAC documentation collection focuses on Corporate Affairs Commission registration materials that verify business entity status and regulatory compliance within applicable jurisdictions.

The document upload interface architecture incorporates file format validation systems that ensure submitted documents meet processing requirements while implementing file size optimization algorithms that maintain document quality during transmission and storage activities. The upload functionality provides real-time validation feedback that alerts designers to format issues, file size limitations, or documentation completeness concerns before submission completion. The step 620 implements secure transmission protocols that encrypt document data during upload processes while maintaining processing efficiency and document integrity throughout validation workflows. The upload system incorporates progress tracking mechanisms that provide visual feedback during file transmission activities while enabling upload resumption capabilities for interrupted transmission sessions.

As further shown in FIG. 6, the step 630 processes submitted documentation through external validation services that authenticate document legitimacy and verify designer credentials through established identity verification protocols. The verification process uses Prembly API for document processing and validation, implemented through secure API integration that transmits document data to external validation services while maintaining data security and processing efficiency standards. The Prembly API integration architecture enables automated document analysis that examines identification materials, business documentation, and regulatory compliance certificates through machine learning algorithms and database cross-referencing systems. The external validation processing incorporates fraud detection mechanisms that identify document tampering, forgery attempts, and identity misrepresentation through advanced analysis techniques and comparative database verification.

The API integration framework implements secure data transmission protocols that protect sensitive document information during external processing while maintaining compliance with data protection regulations and privacy standards. The validation processing architecture incorporates response handling systems that interpret API validation results and translate external service responses into platform-compatible verification status indicators. The step 630 provides processing status tracking that informs designers about validation progress while implementing timeout handling mechanisms that address processing delays or service availability issues. The external validation system incorporates retry mechanisms that handle temporary service interruptions while maintaining verification workflow continuity and designer experience quality.

The step 640 processes validation results and implements badge assignment functionality that adds Verified Badge elements to designer profiles upon successful document authentication and compliance verification. The badge assignment mechanism operates through automated systems that evaluate validation results and apply trust indicators to designer profiles when verification criteria are satisfied. The Verified Badge implementation incorporates visual design elements that communicate trust status to marketplace users while maintaining consistent presentation standards across different interface contexts and device platforms. The badge assignment process integrates with designer profile management systems to update trust indicators in real-time while synchronizing badge status across multiple platform interfaces and user interaction points.

With continued reference to FIG. 6, the badge assignment architecture incorporates verification timestamp recording that documents completion dates and maintains audit trails for compliance monitoring and trust indicator validation. The Verified Badge system implements persistent display functionality that ensures trust indicators remain visible across designer profile presentations, marketplace listings, and communication interfaces throughout designer platform participation. The step 640 provides badge status synchronization across multiple platform components including search results, designer directories, and order management interfaces to ensure consistent trust indicator presentation. The badge assignment process incorporates revocation mechanisms that enable trust indicator removal when verification status changes or compliance issues arise during ongoing platform participation.

The step 650 implements service access control mechanisms that restrict custom order acceptance capabilities to verified designers while maintaining platform security and user trust standards. The access control architecture evaluates designer verification status before enabling order processing functionality and prevents unverified service providers from accepting custom design requests through systematic permission validation. The restriction implementation operates through real-time verification status checking that evaluates badge assignment status during order initiation workflows while providing clear communication to users about designer verification requirements. The step 650 incorporates exception handling systems that address verification status changes during active order processing while maintaining order integrity and user experience continuity.

As further shown in FIG. 6, the step 660 implements customer-facing trust indicator display functionality that presents “Verified Designer” badge elements to users during profile browsing activities and designer selection processes. The badge display architecture incorporates prominent visual placement that ensures trust indicators are visible during designer discovery workflows while maintaining interface design consistency and user experience quality. The customer presentation system provides badge explanation functionality that educates users about verification processes and trust indicator significance through accessible information displays and help documentation. The step 660 integrates badge display functionality across multiple user interface contexts including marketplace feeds, designer profile pages, search results, and communication interfaces to ensure consistent trust indicator visibility throughout user interaction workflows. The trust indicator presentation system incorporates accessibility features that ensure badge visibility across different device platforms, screen sizes, and user accessibility requirements while maintaining verification status communication effectiveness.

Referring to FIG. 7, the method 700 establishes a comprehensive artificial intelligence chatbot assistance framework that delivers automated customer service functionality through intelligent query processing and contextual response generation across the platform ecosystem. The method 700 operates through sequential interaction stages that guide users from initial help activation through query resolution while maintaining integration with human support escalation pathways for complex assistance requirements. The artificial intelligence chatbot architecture incorporates natural language processing algorithms, intent recognition systems, and response generation capabilities that analyze user queries and deliver contextual assistance through conversational interfaces. The chatbot system integrates with platform databases, user account information, and real-time inventory data to provide accurate and personalized assistance responses that address specific user circumstances and platform interactions.

The step 710 initiates the chatbot assistance workflow when users activate “Help” options or initiate chat queries through accessible interface elements positioned throughout the platform ecosystem. The help activation mechanism provides multiple entry points including dedicated help buttons, contextual assistance links, and voice-activated query initiation systems that accommodate different user interaction preferences and accessibility requirements. The chat query initiation functionality recognizes natural language input patterns and activates appropriate response processing algorithms based on query content analysis and user context evaluation. The step 710 incorporates user authentication integration that personalizes chatbot interactions based on account status, order history, and previous assistance interactions while maintaining conversation continuity across multiple platform sessions and device transitions.

With continued reference to FIG. 7, the step 720 generates comprehensive chatbot greeting messages and presents structured quick option selections that guide users toward common assistance categories and frequently requested information. The greeting message generation system personalizes welcome communications based on user account information, recent platform activity, and time-based contextual factors that enhance interaction relevance and user engagement. The quick option presentation architecture organizes assistance categories including order tracking, designer discovery, payment support, and technical troubleshooting through interactive button interfaces that enable rapid navigation to specific assistance areas. The option selection system incorporates usage analytics that prioritize frequently accessed assistance categories while adapting quick option presentations based on user behavior patterns and seasonal platform activity trends.

The step 730 processes diverse user queries including specific requests for trending fashion items, marketplace information, designer recommendations, and technical support through advanced natural language processing algorithms and intent classification systems. The query processing architecture analyzes user input through semantic understanding algorithms that identify query intent, extract relevant parameters, and determine appropriate response strategies based on query complexity and information requirements. The trending fashion item processing functionality accesses real-time marketplace data, user interaction analytics, and designer portfolio information to generate current fashion recommendations that align with user preferences and market activity patterns. The marketplace information processing system retrieves platform data including designer availability, fabric inventory, pricing information, and service specifications through database integration and real-time data synchronization mechanisms.

As further shown in FIG. 7, the step 740 delivers comprehensive chatbot responses containing personalized recommendations and relevant link references to designer profiles, product listings, and platform functionality areas that address user query requirements. The response generation system incorporates dynamic content assembly that combines textual explanations, visual elements, and interactive links through structured presentation formats that enhance information accessibility and user engagement. The recommendation delivery functionality analyzes user preferences, browsing history, and query context to generate personalized suggestions that align with individual style preferences and platform interaction patterns. The link reference system provides direct navigation pathways to relevant platform sections including designer profiles, fabric catalogs, order management interfaces, and educational resources that support user query resolution and platform exploration activities.

The step 750 implements sophisticated escalation mechanisms that transfer conversations to human support specialists when automated responses prove insufficient for complex query resolution and specialized assistance requirements. The AI chatbot method includes escalation to human support specialists for complex queries through intelligent escalation detection algorithms that evaluate query complexity, user satisfaction indicators, and response adequacy metrics to determine when human intervention becomes beneficial. The escalation detection system analyzes conversation patterns, repeated query attempts, and user feedback signals to identify situations where artificial intelligence responses fail to address user requirements effectively. The human specialist transfer functionality preserves conversation context, query history, and user account information during escalation processes while providing support specialists with comprehensive background information that enables efficient assistance continuation.

With continued reference to FIG. 7, the escalation architecture incorporates queue management systems that coordinate specialist availability, workload distribution, and response time optimization to ensure timely human assistance delivery during peak support periods. The specialist assignment algorithms evaluate query categories, specialist expertise areas, and current workload distributions to match users with appropriate support personnel who possess relevant knowledge and experience for specific assistance requirements. The escalation process maintains conversation threading that preserves artificial intelligence interaction history while enabling seamless transitions between automated and human assistance without information loss or context disruption. The human specialist integration provides access to advanced platform tools, administrative capabilities, and specialized knowledge resources that enable comprehensive problem resolution for complex technical issues, account management requirements, and specialized platform functionality questions.

The artificial intelligence chatbot system architecture incorporates continuous learning mechanisms that analyze conversation outcomes, user satisfaction metrics, and query resolution effectiveness to improve automated response capabilities and reduce escalation requirements over time. The learning algorithms process successful interaction patterns, frequently asked questions, and user feedback data to expand chatbot knowledge bases and enhance response accuracy for common assistance scenarios. The system performance monitoring functionality tracks response times, query resolution rates, and user satisfaction scores to identify improvement opportunities and optimize chatbot functionality across different assistance categories and user interaction contexts. The chatbot integration with platform analytics systems enables comprehensive performance assessment that measures assistance effectiveness, user engagement levels, and support cost optimization while maintaining service quality standards and user experience expectations throughout the automated assistance delivery process.

Referring to FIG. 8, the method 800 establishes a sophisticated artificial intelligence recommendation engine that analyzes comprehensive user behavioral data to generate personalized content suggestions and enhance platform engagement through targeted discovery experiences. The method 800 operates through interconnected data collection and analysis systems that monitor user interactions across multiple platform touchpoints while generating dynamic recommendation outputs that adapt to evolving user preferences and behavioral patterns. The artificial intelligence recommendation architecture incorporates machine learning algorithms, collaborative filtering techniques, and content-based recommendation systems that process diverse data inputs to identify user preference patterns and generate contextually relevant suggestions for designers, fabrics, and design styles. The recommendation engine integrates with the broader platform ecosystem to access real-time inventory data, designer availability information, and marketplace activity metrics while maintaining processing efficiency and recommendation accuracy across diverse user populations and interaction scenarios.

The step 810 implements comprehensive data collection systems that gather browsing patterns, search histories, save actions, and purchase data from user interactions across all platform interfaces and functionality areas. The browsing pattern collection architecture monitors user navigation behaviors including page visit durations, scroll patterns, interface element interactions, and content engagement metrics that reveal user interest levels and preference indicators. The search history analysis systems capture query terms, filter selections, result interactions, and search refinement patterns that demonstrate user intent and style preferences across different fashion categories and designer specializations. The save action tracking functionality records user selections for favorites, wish list additions, and bookmark activities that indicate strong interest levels and potential purchase intent for specific designers, fabrics, or design styles. The purchase data collection encompasses transaction histories, order specifications, designer selections, and completion patterns that provide definitive indicators of user preferences and successful platform interactions.

With continued reference to FIG. 8, the data collection infrastructure incorporates real-time processing capabilities that capture user interactions as events occur while maintaining data integrity and processing efficiency across high-volume user activity periods. The behavioral data aggregation systems organize collected information into user profile structures that maintain historical interaction records while enabling rapid access for recommendation generation algorithms. The step 810 implements privacy protection measures that anonymize sensitive user information while preserving behavioral pattern data for recommendation processing activities. The data collection architecture incorporates cross-device tracking capabilities that maintain user behavior continuity across multiple platform access points including mobile applications, web interfaces, and tablet implementations through secure user authentication and session management systems.

The step 820 generates recommendation displays under “For You” sections on home feed interfaces and product page locations through dynamic content assembly systems that organize personalized suggestions into visually appealing presentation formats. The recommendation display architecture incorporates adaptive layout systems that adjust content organization based on screen sizes, device capabilities, and user interface preferences while maintaining consistent presentation quality across different platform access methods. The “For You” section implementation utilizes prominent placement strategies that position personalized recommendations within primary navigation flows to maximize user exposure and engagement opportunities. The product page recommendation integration provides contextually relevant suggestions that complement currently viewed content while encouraging exploration of related designers, fabrics, and design styles that align with demonstrated user interests.

As further shown in FIG. 8, the recommendation presentation systems incorporate visual hierarchy principles that emphasize high-quality imagery, clear designer identification, and relevant metadata including ratings, pricing, and availability information that support informed user decision-making processes. The display functionality implements infinite scroll mechanisms that load additional recommendations as users engage with presented content while maintaining interface responsiveness and content quality standards. The step 820 integrates with user interaction tracking systems that monitor recommendation engagement metrics including click-through rates, save actions, and conversion patterns that inform recommendation algorithm refinement and performance optimization activities. The recommendation display architecture incorporates accessibility features that ensure content visibility across different user capabilities and assistive technology requirements while maintaining recommendation effectiveness and user experience quality.

The step 830 delivers comprehensive suggestions encompassing designers, fabrics, and designs tailored to individual user preferences and behavioral patterns through multi-dimensional recommendation algorithms that analyze diverse preference indicators and content attributes. The designer recommendation systems evaluate user interaction histories with specific service providers while analyzing designer specializations, style categories, and service quality metrics to identify compatible matches that align with user preferences and project requirements. The fabric recommendation functionality processes user material preferences, project types, and style selections to suggest appropriate textiles from marketplace inventory while considering factors including cultural significance, seasonal relevance, and design compatibility. The design recommendation algorithms analyze user style preferences, occasion requirements, and aesthetic choices to surface relevant design examples and inspiration content that support creative decision-making and project development activities.

With continued reference to FIG. 8, the tailored suggestion generation incorporates collaborative filtering techniques that identify users with similar preference patterns and recommend content based on successful interactions within comparable user segments. The recommendation algorithms implement content-based filtering approaches that analyze item attributes, designer characteristics, and style metadata to identify similar content that aligns with demonstrated user preferences and interaction patterns. The step 830 incorporates hybrid recommendation approaches that combine multiple algorithmic techniques to generate comprehensive suggestion sets that address different aspects of user preferences while maintaining recommendation diversity and discovery opportunities. The personalized suggestion systems implement novelty algorithms that balance familiar content recommendations with discovery opportunities that introduce users to new designers, styles, and fabric options that expand platform engagement and creative exploration possibilities.

The step 840 provides contextual suggestions based on user interaction patterns through sophisticated pattern recognition algorithms that identify behavioral sequences and generate relevant recommendations that align with demonstrated user interests and project development activities. The contextual recommendation system analyzes specific user actions including wedding gown saves, formal wear browsing, and cultural style exploration to generate targeted suggestions that address related project requirements and style preferences. The wedding-focused recommendation functionality identifies users demonstrating bridal interest patterns and suggests specialized wedding fabric vendors and designers with established reputations and high ratings in bridalwear categories. The formal wear recommendation systems recognize users exploring professional attire options and suggest appropriate designers, fabric selections, and style references that support business wardrobe development and special occasion requirements.

As further shown in FIG. 8, the pattern-based suggestion algorithms incorporate temporal analysis that considers seasonal trends, cultural events, and fashion calendar influences to generate timely recommendations that align with current market conditions and user planning activities. The contextual recommendation architecture analyzes user project timelines, event planning activities, and seasonal browsing patterns to suggest appropriate designers and materials that accommodate project scheduling requirements and delivery expectations. The step 840 implements cross-category recommendation systems that identify connections between different fashion categories and suggest complementary items including accessories, styling options, and coordinating pieces that enhance overall project outcomes. The contextual suggestion functionality incorporates location-based recommendations that consider user geographic locations, cultural contexts, and regional style preferences to generate locally relevant suggestions that align with cultural significance and practical considerations.

The step 850 implements dynamic recommendation updates that continuously refine suggestion algorithms based on ongoing user engagement data and interaction feedback throughout extended platform usage periods. The recommendation method updates dynamically as users interact more with the platform through sophisticated learning algorithms that process new behavioral data and adjust recommendation parameters to improve suggestion accuracy and relevance over time. The dynamic update architecture incorporates real-time feedback processing that analyzes user responses to presented recommendations including engagement rates, conversion actions, and negative feedback indicators to refine algorithmic performance and suggestion quality. The continuous refinement systems implement machine learning techniques that identify evolving user preferences, seasonal behavior changes, and style development patterns to adapt recommendation strategies and maintain suggestion relevance across extended user engagement periods.

With continued reference to FIG. 8, the dynamic update functionality incorporates A/B testing frameworks that evaluate different recommendation approaches and algorithmic parameters to optimize suggestion effectiveness and user engagement outcomes through systematic performance comparison and statistical analysis. The recommendation refinement algorithms process aggregate user feedback data to identify successful recommendation patterns and adjust algorithmic weights to emphasize effective suggestion strategies while reducing less successful recommendation approaches. The step 850 implements recommendation diversity algorithms that balance personalized suggestions with discovery opportunities to prevent recommendation narrowing and maintain user exposure to new designers, styles, and creative possibilities throughout platform engagement. The dynamic update architecture incorporates performance monitoring systems that track recommendation effectiveness metrics including click-through rates, conversion percentages, and user satisfaction indicators to guide algorithmic improvements and maintain recommendation system performance standards across diverse user populations and interaction scenarios.

Referring to FIG. 9, the method 900 establishes a comprehensive fabric and product sales framework that expands the platform's marketplace functionality beyond custom design services to encompass physical goods commerce through integrated shopping and payment processing systems. The method 900 operates through sequential e-commerce workflows that guide users from product discovery through purchase completion while maintaining integration with the broader platform ecosystem including user accounts, payment infrastructure, and order management systems. The fabric and product sales architecture incorporates diverse product categories that encompass traditional textile materials alongside ready-to-wear garments and fashion accessories through unified marketplace interfaces. The method 900 integrates with inventory management systems, supplier networks, and fulfillment services to provide comprehensive product availability information, pricing data, and shipping coordination capabilities across global marketplace operations.

The step 910 initiates the product marketplace experience when users access fabric and products marketplace interfaces through dedicated navigation pathways within the platform ecosystem. The marketplace access mechanism provides users with direct entry points to product browsing areas that organize available inventory through categorized displays and search functionality. The interface activation triggers content loading sequences that populate product displays with current inventory information, pricing data, and availability status indicators while maintaining responsive performance across different device platforms and network conditions. The step 910 incorporates user authentication integration that personalizes marketplace experiences based on account preferences, browsing histories, and previous purchase patterns while providing guest browsing capabilities for users exploring product offerings without account registration.

With continued reference to FIG. 9, the step 920 enables comprehensive browsing functionality for diverse product categories through organized interface layouts that present available inventory across multiple merchandise classifications. The fabric sales method includes ready-to-wear clothing and accessories in addition to fabrics, implemented through expanded product categorization systems that organize marketplace inventory into textile materials, completed garments, and fashion accessories through structured navigation hierarchies. The fabric category encompasses traditional textiles, cultural materials, luxury fabrics, and specialty textiles sourced from global suppliers and designer collections. The ready-to-wear clothing category includes completed garments across diverse style categories including casual wear, formal attire, cultural garments, and seasonal collections from verified designers and fashion brands. The accessories category incorporates jewelry, bags, shoes, and complementary fashion items that coordinate with custom design projects and ready-to-wear selections.

The browsing interface architecture utilizes grid-based product displays that showcase high-resolution product imagery, pricing information, and availability indicators through consistent presentation formats that enable efficient product comparison and selection activities. The product presentation systems incorporate filtering mechanisms that enable users to refine browsing results based on price ranges, material types, style categories, designer origins, and cultural significance factors. The step 920 implements infinite scroll functionality that loads additional product content as users navigate through extensive inventory collections while maintaining interface responsiveness and image quality standards. The browsing system integrates with recommendation algorithms that suggest related products and complementary items based on user viewing patterns and product attribute similarities.

As further shown in FIG. 9, the step 930 presents comprehensive product detail pages that consolidate pricing information, inventory levels, customer review data, and shipping specifications through organized information displays that support informed purchasing decisions. The product detail architecture incorporates multiple product imagery including detail shots, color variations, and styling examples that provide comprehensive visual product representation. The pricing display systems present current product costs alongside promotional pricing, bulk purchase discounts, and shipping cost calculations that enable accurate total cost assessment before purchase commitment. The stock level indicators communicate product availability through real-time inventory tracking that prevents overselling while providing availability notifications for out-of-stock items.

The review data integration within product detail pages displays customer feedback, rating distributions, and detailed testimonials that provide social proof and quality indicators for product evaluation. The review presentation systems organize customer feedback through chronological displays and rating-based sorting that enable users to assess product quality and customer satisfaction levels. The shipping specification sections provide detailed delivery information including shipping methods, estimated delivery timeframes, international shipping availability, and tracking capabilities that inform purchase planning and expectation setting. The step 930 incorporates size guides, material specifications, and care instructions that provide technical product information supporting appropriate product selection and usage guidance.

The step 940 implements integrated shopping cart functionality and streamlined checkout processes that enable users to accumulate multiple product selections and complete purchases through unified transaction workflows. The cart functionality provides persistent storage for selected products across browsing sessions while maintaining product availability verification and pricing accuracy throughout the selection process. The cart interface displays accumulated product selections through organized lists that include product imagery, quantity selectors, pricing information, and removal options that enable cart management and modification activities. The checkout process activation transitions users from product selection to payment processing through guided workflows that collect shipping information, payment details, and delivery preferences.

With continued reference to FIG. 9, the checkout architecture incorporates address validation systems that verify shipping destinations and calculate accurate delivery costs based on product dimensions, shipping methods, and destination locations. The checkout process provides multiple shipping options including standard delivery, expedited shipping, and international shipping services that accommodate different delivery timeline requirements and budget considerations. The step 940 integrates with user account systems to populate shipping addresses, payment methods, and preference settings from stored account information while providing guest checkout options for users preferring transaction completion without account creation. The cart and checkout systems implement session management capabilities that preserve selection and progress information across device transitions and browsing interruptions.

The step 950 processes payment completion through integrated gateway systems that connect with the platform's secure payment infrastructure while maintaining transaction security and processing efficiency standards. The payment processing architecture supports multiple payment methods including credit cards, digital wallets, bank transfers, and regional payment systems that accommodate diverse user preferences and geographic payment requirements. The integrated gateway systems implement real-time transaction processing that provides immediate payment confirmation while maintaining compliance with financial regulations and security standards across different jurisdictions. The payment completion workflows incorporate fraud detection mechanisms that analyze transaction patterns and risk indicators to prevent unauthorized purchases while minimizing legitimate transaction disruptions.

As further shown in FIG. 9, the payment processing systems integrate with inventory management platforms to automatically update product availability and reserve purchased items for fulfillment processing. The transaction completion triggers automated confirmation systems that generate purchase receipts, order tracking information, and delivery scheduling communications through email and in-application messaging systems. The step 950 incorporates currency conversion capabilities that enable international transactions while displaying pricing in user-preferred currencies and handling exchange rate calculations transparently. The payment infrastructure maintains transaction records and audit trails that support order management, customer service, and financial reporting requirements while protecting sensitive payment information through encryption and secure storage protocols.

The step 960 provides comprehensive delivery tracking capabilities through My Orders interfaces that enable users to monitor shipment progress and delivery status updates throughout fulfillment processes. The tracking system architecture integrates with shipping carrier networks to provide real-time shipment location information, delivery progress updates, and estimated arrival timeframes through automated status synchronization. The My Orders interface organizes purchase histories through chronological displays that include order details, tracking information, delivery confirmations, and post-purchase support options. The tracking functionality provides proactive notifications that alert users about shipment milestones including order processing, shipping dispatch, transit progress, and delivery completion through push notifications and email communications.

With continued reference to FIG. 9, the delivery tracking systems incorporate exception handling capabilities that address shipping delays, delivery issues, and customer service requirements through integrated support workflows and communication channels. The tracking interface provides direct access to shipping carrier information, delivery modification options, and customer service contacts that enable users to address delivery concerns and coordinate special delivery requirements. The step 960 integrates with customer service systems to provide seamless support escalation for delivery issues while maintaining order context and customer history information. The delivery tracking architecture incorporates feedback collection mechanisms that enable users to rate delivery experiences and provide input for service improvement while supporting quality assurance and carrier performance evaluation activities.

Referring to FIG. 10, the method 1000 establishes a comprehensive review and rating framework that facilitates transparent feedback collection and credibility assessment within the marketplace platform through systematic post-purchase evaluation processes. The method 1000 operates through sequential feedback workflows that guide users from order completion through review publication while implementing verification mechanisms that authenticate reviewer credentials and prevent fraudulent feedback submission. The review and rating architecture incorporates dual-sided communication capabilities that enable both customer feedback submission and designer response functionality through integrated interface systems that support transparent marketplace interactions. The method 1000 connects with order management systems, user authentication databases, and designer profile management platforms to coordinate review timing, verify purchase completion status, and maintain feedback integrity throughout the evaluation process.

The step 1010 initiates the feedback collection sequence when users receive notification prompts following order completion or delivery events, requesting comprehensive evaluation of designer performance and overall experience quality. The notification delivery system activates automated messaging sequences that trigger at predetermined intervals following order fulfillment milestones including delivery confirmation, project completion, or service conclusion events. The notification architecture incorporates personalized messaging content that references specific order details, designer names, and project specifications to provide contextual prompts that encourage detailed feedback submission. The step 1010 integrates with delivery tracking systems and order status monitoring platforms to ensure notification timing aligns with actual service completion rather than estimated timelines, preventing premature review requests that compromise feedback accuracy and user experience quality.

With continued reference to FIG. 10, the notification system incorporates multiple communication channels including push notifications, email communications, and in-application messaging systems that deliver review requests through user-preferred contact methods while maintaining consistent messaging content and call-to-action elements. The notification delivery architecture implements timing optimization algorithms that schedule review requests during periods of high user engagement while avoiding notification fatigue through strategic spacing and frequency management. The step 1010 provides notification customization capabilities that adapt messaging tone and content based on order types, designer categories, and user interaction histories to enhance response rates and feedback quality. The notification system incorporates reminder sequences that deliver follow-up prompts for users who do not respond to initial review requests while maintaining respectful communication frequency that avoids user experience degradation.

The step 1020 enables comprehensive rating selection and review composition functionality through structured interface elements that guide users through systematic evaluation processes covering multiple service dimensions and experience aspects. The rating interface presents multi-dimensional evaluation scales that enable users to assess designer communication quality, project timeline adherence, design execution accuracy, and overall satisfaction levels through numerical rating systems and qualitative feedback options. The review composition functionality provides text input areas with character count guidance, formatting options, and suggestion prompts that encourage detailed feedback submission while maintaining review quality standards. The step 1020 incorporates rating validation mechanisms that prevent incomplete submissions and encourage comprehensive evaluation through interface prompts and completion indicators that guide users toward thorough feedback provision.

The rating selection architecture implements intuitive interface designs including star-based rating systems, slider controls, and categorical evaluation options that accommodate different user preferences for feedback expression while maintaining consistent data collection standards across diverse user populations. The review composition interface incorporates real-time character counting, spell-checking capabilities, and formatting assistance that support clear communication and professional presentation of user feedback. The step 1020 provides review preview functionality that enables users to review submitted content before publication while offering editing capabilities and revision options that ensure feedback accuracy and user satisfaction with published reviews. The evaluation interface incorporates accessibility features including screen reader compatibility, keyboard navigation support, and adjustable text sizing that accommodate diverse user capabilities while maintaining feedback collection effectiveness.

As further shown in FIG. 10, the step 1030 implements comprehensive verification mechanisms that authenticate reviewer credentials and restrict feedback submission capabilities to users who have completed verified purchase transactions. The review method restricts review submission to verified buyers only to prevent fake ratings through systematic validation processes that cross-reference user accounts with completed order records and payment confirmations. The verification architecture analyzes user transaction histories, order completion status, and payment processing records to establish legitimate reviewer credentials before enabling feedback submission capabilities. The step 1030 incorporates fraud detection algorithms that identify suspicious review patterns, duplicate account activities, and coordinated rating manipulation attempts through behavioral analysis and account relationship mapping.

The buyer verification system implements multi-factor authentication processes that confirm user identity, validate purchase completion, and verify service delivery before granting review submission permissions. The verification mechanisms incorporate temporal validation that ensures adequate time has elapsed between service completion and review submission to enable informed evaluation while preventing immediate emotional responses that compromise feedback objectivity. The step 1030 provides verification status indicators that communicate reviewer credentials to other marketplace users through badge systems and authentication markers that establish review credibility and trustworthiness. The verification architecture maintains audit trails that document reviewer validation processes, authentication timestamps, and verification criteria fulfillment to support review integrity monitoring and dispute resolution activities.

With continued reference to FIG. 10, the verification system incorporates machine learning algorithms that analyze review content, submission patterns, and user behavior indicators to identify potentially fraudulent feedback and flag suspicious activities for manual review and investigation. The automated verification processes evaluate review authenticity through linguistic analysis, sentiment consistency evaluation, and comparative assessment against verified purchase details to detect fabricated or manipulated feedback content. The step 1030 implements verification badge display systems that communicate authenticated reviewer status to marketplace users while providing transparency about review credibility and validation processes. The verification infrastructure incorporates appeal mechanisms that enable users to contest verification decisions and provide additional documentation to establish reviewer credentials when automated systems produce incorrect validation results.

The step 1040 implements comprehensive review publication systems that display customer feedback content on designer profiles and product listing pages throughout the marketplace interface while maintaining organized presentation formats and accessibility standards. The review display architecture incorporates chronological organization systems that present feedback in temporal order while providing sorting options including rating-based organization, relevance ranking, and category-specific filtering that enable users to locate pertinent feedback information efficiently. The publication system integrates review content with designer profile presentations through dedicated feedback sections that showcase customer testimonials, rating distributions, and detailed evaluation summaries within professional profile layouts. The step 1040 provides review aggregation functionality that calculates average ratings, satisfaction percentages, and performance metrics based on collected feedback data while presenting statistical summaries that support rapid designer evaluation and comparison activities.

The review publication interface incorporates visual presentation elements including rating displays, review excerpts, and customer testimonial highlights that enhance profile attractiveness while maintaining authentic feedback representation and user trust indicators. The display system implements responsive design principles that ensure review content accessibility across different device platforms and screen sizes while maintaining readability and presentation quality standards. The step 1040 provides review filtering capabilities that enable profile visitors to focus on specific feedback categories, rating ranges, or temporal periods through interactive filtering controls that customize review displays based on user interests and evaluation criteria. The publication architecture incorporates review helpfulness indicators that enable users to rate feedback quality and relevance while providing community-driven quality assessment mechanisms that highlight valuable reviews and improve overall feedback utility.

As further shown in FIG. 10, the step 1050 enables comprehensive designer response functionality that allows service providers to publish replies to customer reviews through structured communication interfaces that support transparent dialogue and credibility enhancement activities. The review method allows designers to reply publicly to reviews for credibility building through integrated response systems that enable professional communication and issue resolution within public marketplace contexts. The designer response architecture provides text composition interfaces with formatting capabilities, character limits, and professional communication guidelines that encourage constructive dialogue and maintain marketplace communication standards. The step 1050 incorporates response notification systems that alert designers about new reviews requiring attention while providing dashboard interfaces that organize pending response opportunities and track communication completion status.

The public response functionality enables designers to address customer concerns, clarify project circumstances, acknowledge feedback appreciation, and demonstrate professional communication capabilities through visible marketplace interactions that influence reputation assessment and future customer decision-making processes. The response interface incorporates professional communication templates, suggested response frameworks, and tone guidance that support effective customer relationship management while maintaining authentic communication and personal expression capabilities. The step 1050 provides response editing capabilities that enable designers to revise published replies while maintaining response history and transparency about communication modifications through timestamp tracking and revision indicators. The designer response system incorporates moderation capabilities that ensure response content adheres to marketplace communication standards while preventing inappropriate or unprofessional communication that compromises platform reputation and user experience quality.

With continued reference to FIG. 10, the designer response architecture incorporates response analytics that track engagement metrics, customer satisfaction improvements, and reputation enhancement outcomes resulting from public reply activities. The response system provides designers with communication effectiveness feedback including response rates, customer appreciation indicators, and reputation impact assessments that guide communication strategy development and professional development activities. The step 1050 integrates response functionality with designer performance tracking systems that incorporate communication quality assessments into overall service provider evaluation metrics and marketplace ranking algorithms. The public response infrastructure maintains conversation threading that preserves customer-designer dialogue context while enabling extended communication sequences that demonstrate ongoing customer service commitment and professional relationship management capabilities throughout post-project interaction periods.

Referring to FIG. 11, the method 1100 establishes a comprehensive abandoned browsing notification framework that addresses user engagement scenarios where potential customers demonstrate interest in specific products or designers but exit platform interfaces without completing purchase transactions or booking activities. The method 1100 operates through sophisticated behavioral tracking systems that monitor user interaction patterns and implement targeted re-engagement strategies designed to convert passive browsing activities into active marketplace participation. The abandoned browsing detection architecture incorporates real-time user behavior analysis that identifies exit patterns, engagement duration metrics, and interaction depth indicators to determine when users demonstrate purchase intent but fail to complete transaction workflows. The notification system integrates with user preference management platforms, communication delivery infrastructure, and spam prevention mechanisms to ensure re-engagement messaging remains effective while respecting user experience boundaries and communication frequency limitations.

The step 1110 initiates the abandoned browsing tracking sequence when users access designer profiles or product pages within the marketplace ecosystem, establishing baseline engagement monitoring that captures user interaction patterns and interest indicators. The browsing detection system implements comprehensive activity logging that records page visit durations, scroll patterns, image interactions, and interface element engagement to establish user interest levels and purchase intent indicators. The tracking architecture monitors specific user actions including profile viewing, portfolio browsing, product examination, and pricing review activities that demonstrate active consideration of purchase or booking decisions. The step 1110 incorporates session management capabilities that maintain user activity context across multiple page visits and browsing sessions while preserving interaction history for subsequent notification targeting and personalization activities.

With continued reference to FIG. 11, the behavioral tracking system implements sophisticated engagement scoring algorithms that evaluate user interaction intensity, time investment, and content exploration depth to identify high-intent browsing sessions that warrant follow-up communication efforts. The tracking mechanisms incorporate device fingerprinting and session continuity management that maintain user behavior monitoring across different access methods and platform interfaces while respecting privacy protection standards and user consent requirements. The step 1110 integrates with user authentication systems to associate browsing behaviors with specific user accounts while providing anonymous tracking capabilities for guest users exploring marketplace content without registration. The engagement monitoring architecture incorporates real-time data processing that enables immediate behavioral pattern recognition and notification trigger evaluation without compromising platform performance or user experience responsiveness.

The step 1112 implements comprehensive exit behavior detection systems that identify when users leave platform interfaces without completing desired actions including booking confirmations, cart additions, or purchase transactions. The exit detection architecture utilizes multiple behavioral indicators including navigation away from product pages, browser closure events, application backgrounding activities, and session timeout occurrences to determine when users abandon potential purchase workflows. The tracking system incorporates intent inference algorithms that analyze user interaction patterns immediately preceding exit events to distinguish between casual browsing activities and high-intent sessions that warrant re-engagement efforts. The step 1112 provides exit context analysis that evaluates specific abandonment points within user workflows to inform subsequent notification content and timing strategies.

As further shown in FIG. 11, the exit behavior monitoring system implements sophisticated pattern recognition capabilities that differentiate between various abandonment scenarios including price sensitivity exits, comparison shopping activities, decision postponement behaviors, and technical difficulty departures. The detection algorithms analyze user interaction sequences, engagement duration patterns, and interface element interactions to categorize abandonment reasons and inform appropriate re-engagement messaging strategies. The step 1112 incorporates cross-session tracking that identifies users who repeatedly browse specific designers or products across multiple platform visits without completing transactions, indicating sustained interest levels that justify targeted notification campaigns. The exit detection infrastructure maintains detailed abandonment analytics that document exit points, session characteristics, and user behavior patterns to support notification optimization and engagement strategy refinement activities.

The step 1114 establishes strategic waiting period implementation that introduces appropriate time intervals between user exit detection and notification activation to prevent immediate messaging that compromises user experience or appears overly aggressive in re-engagement approach. The waiting period architecture incorporates dynamic timing algorithms that adjust notification delays based on user behavior patterns, engagement intensity levels, and historical response data to optimize message timing for maximum effectiveness. The timing system implements multiple delay strategies including short-term reminders for high-intent sessions and extended delays for casual browsing activities to match notification timing with user decision-making processes and consideration periods. The step 1114 provides timing customization capabilities that adapt waiting periods based on product categories, price points, and user demographic characteristics to align notification delivery with appropriate decision-making timeframes.

With continued reference to FIG. 11, the waiting period management system incorporates user preference integration that respects individual communication timing preferences and frequency limitations established through account settings and previous interaction feedback. The timing algorithms analyze user response patterns to previous notifications to identify optimal delivery windows and avoid communication during periods of low engagement or negative response likelihood. The step 1114 implements timezone-aware scheduling that ensures notification delivery occurs during appropriate hours based on user location data and activity pattern analysis to maximize message visibility and response potential. The waiting period architecture incorporates holiday and cultural event awareness that adjusts notification timing to avoid inappropriate messaging during religious observances, cultural celebrations, or personal milestone periods that compromise message reception and user experience quality.

The step 1116 generates sophisticated contextual pop-up messages and push notifications designed to re-engage users with previously viewed content through personalized messaging that references specific products, designers, or browsing activities. The notification generation system incorporates dynamic content assembly that combines user-specific browsing data with persuasive messaging frameworks to create compelling re-engagement communications that address individual user interests and demonstrated preferences. The contextual messaging architecture utilizes behavioral data analysis to craft notifications that reference specific designers viewed, products examined, or style categories explored during abandoned browsing sessions. The step 1116 implements personalization algorithms that adapt message tone, content emphasis, and call-to-action elements based on user demographic characteristics, engagement history, and response pattern analysis.

As further shown in FIG. 11, the notification content generation system incorporates urgency creation techniques including limited-time offers, inventory scarcity indicators, and exclusive access opportunities that encourage immediate action while maintaining authentic messaging that reflects actual marketplace conditions. The contextual messaging framework provides multiple message variations that prevent repetitive communication while maintaining consistent brand voice and persuasive effectiveness across different notification instances. The step 1116 integrates with real-time inventory systems to ensure notification content accuracy regarding product availability, pricing information, and designer accessibility to prevent user frustration resulting from outdated or incorrect information. The notification generation architecture incorporates A/B testing capabilities that evaluate different messaging approaches and optimize content effectiveness through systematic performance comparison and user response analysis.

The step 1118 implements comprehensive spam prevention mechanisms that restrict notification frequency to prevent user experience degradation while maintaining effective re-engagement communication strategies. The notification process includes abandoned browsing reminders with a maximum of two reminders per design to avoid spamming through systematic frequency limitation systems that track notification delivery counts and prevent excessive messaging that compromises user satisfaction and platform reputation. The spam prevention architecture maintains detailed notification histories that document message delivery timestamps, content variations, and user response patterns to ensure compliance with frequency limitations and communication best practices. The step 1118 incorporates user feedback integration that monitors unsubscribe rates, complaint indicators, and negative response patterns to identify when notification strategies require adjustment or cessation.

With continued reference to FIG. 11, the frequency limitation system implements sophisticated tracking mechanisms that monitor notification delivery across multiple product categories, designer interactions, and browsing sessions to ensure overall communication volume remains within acceptable user experience boundaries. The spam prevention algorithms incorporate cross-category notification coordination that prevents simultaneous messaging about different products or designers that overwhelm users with multiple concurrent re-engagement attempts. The step 1118 provides user control mechanisms that enable individuals to adjust notification frequency preferences, opt out of specific message categories, or completely disable abandoned browsing communications while maintaining account functionality and platform access. The frequency management architecture incorporates machine learning algorithms that analyze user response patterns and engagement outcomes to optimize notification timing and content for individual users while respecting established frequency limitations and spam prevention protocols.

The abandoned browsing notification system architecture incorporates comprehensive performance monitoring capabilities that track engagement metrics, conversion rates, and user satisfaction indicators to evaluate notification effectiveness and guide system optimization activities. The performance analysis framework measures notification open rates, click-through percentages, conversion completion rates, and user retention impacts resulting from re-engagement messaging campaigns. The monitoring system provides detailed analytics regarding notification timing effectiveness, content variation performance, and frequency optimization outcomes that inform strategic adjustments and campaign refinement activities. The architecture incorporates user journey analysis that tracks complete conversion pathways from initial browsing through notification delivery to final purchase completion, enabling comprehensive assessment of re-engagement campaign effectiveness and return on investment calculations for notification system operations.

Referring to FIG. 12, the process 1200 establishes a comprehensive incomplete consultation booking management framework that addresses scenarios where users initiate designer consultation scheduling but fail to complete required workflow steps including measurement submission and payment processing activities. The process 1200 operates through systematic monitoring mechanisms that track user progress through consultation booking workflows while implementing targeted reminder systems that address specific completion gaps and workflow abandonment points. The incomplete booking detection architecture incorporates real-time progress tracking that monitors user advancement through sequential booking stages while identifying specific abandonment points that warrant targeted intervention and re-engagement messaging. The process 1200 integrates with consultation scheduling systems, payment processing infrastructure, and user communication platforms to coordinate comprehensive booking completion support that addresses diverse abandonment scenarios and workflow interruption causes.

The step 1210 initiates the incomplete booking monitoring sequence when users activate consultation booking functionality with designers through scheduling interfaces within the platform ecosystem. The booking initiation detection system captures user entry into consultation scheduling workflows while establishing baseline tracking that monitors subsequent progress through required completion stages including time slot selection, measurement provision, and payment processing activities. The monitoring architecture implements comprehensive session tracking that maintains user progress context across multiple interface interactions and potential workflow interruptions while preserving booking state information for subsequent completion attempts. The step 1210 incorporates booking identification systems that assign unique tracking identifiers to consultation scheduling sessions while maintaining association with specific designer selections and user account information throughout the booking process.

With continued reference to FIG. 12, the booking initiation tracking system implements sophisticated workflow stage identification that categorizes user progress through distinct consultation booking phases including initial scheduling, measurement collection, payment processing, and confirmation completion. The tracking mechanisms incorporate real-time progress assessment that evaluates user advancement through booking workflows while identifying specific completion requirements that remain unfulfilled at various workflow stages. The step 1210 integrates with designer availability systems to coordinate booking slot reservations while maintaining temporary holds on selected consultation times during user completion processes. The booking monitoring infrastructure incorporates cross-session continuity that preserves booking progress across device transitions and platform access interruptions while maintaining workflow state integrity and completion tracking accuracy.

The step 1220 implements comprehensive completion status monitoring that evaluates user progress against booking workflow requirements while identifying specific failure points including measurement submission gaps and payment processing abandonment scenarios. The completion monitoring architecture analyzes user interaction patterns within booking workflows to distinguish between active completion attempts and workflow abandonment behaviors that warrant intervention messaging. The monitoring system incorporates multi-dimensional progress assessment that evaluates completion status across different booking requirements including scheduling confirmation, measurement data provision, payment method selection, and transaction processing completion. The step 1220 provides real-time completion tracking that updates user progress indicators while maintaining detailed records of completed and outstanding booking requirements for subsequent reminder targeting and workflow resumption support.

As further shown in FIG. 12, the completion status evaluation system implements sophisticated abandonment detection algorithms that identify when users exit booking workflows without completing required steps while distinguishing between temporary interruptions and definitive abandonment behaviors. The monitoring mechanisms incorporate temporal analysis that evaluates time elapsed since last booking interaction to determine appropriate intervention timing and reminder activation thresholds. The step 1220 integrates with payment processing systems to monitor transaction initiation attempts and completion failures while coordinating with measurement collection interfaces to track data submission progress and completion status. The completion monitoring architecture incorporates user behavior analysis that evaluates interaction patterns and engagement indicators to assess completion likelihood and inform reminder messaging strategies and intervention timing decisions.

The step 1230 activates sophisticated reminder notification systems that generate targeted messages addressing specific incomplete booking elements while providing contextual guidance that facilitates workflow completion and addresses identified abandonment causes. The reminder generation architecture implements dynamic content assembly that creates personalized messages referencing specific booking details including designer names, selected consultation times, and outstanding completion requirements. The notification system incorporates contextual messaging frameworks that adapt reminder content based on specific abandonment points including measurement submission reminders for users who have completed scheduling but failed to provide dimensional data, and payment completion prompts for users who have progressed through scheduling and measurement stages but abandoned transaction processing. The step 1230 provides multi-channel reminder delivery through push notifications, email communications, and in-application messaging systems that ensure message visibility across different user engagement patterns and device usage preferences.

With continued reference to FIG. 12, the reminder notification system incorporates urgency calibration mechanisms that adjust message tone and timing based on consultation scheduling proximity and designer availability constraints while maintaining respectful communication that avoids aggressive messaging approaches. The notification content generation utilizes behavioral data analysis to craft reminders that address specific user concerns and potential abandonment causes including payment security reassurance, measurement collection guidance, and scheduling flexibility options. The step 1230 implements reminder personalization algorithms that adapt message content based on user demographic characteristics, previous booking behaviors, and response pattern analysis to optimize engagement effectiveness and completion conversion rates. The notification architecture incorporates designer coordination systems that inform service providers about pending booking completions while enabling collaborative completion support and flexible scheduling adjustments that accommodate user completion timelines.

The step 1240 establishes comprehensive contextual notification customization that generates reminder content specifically tailored to user progress stages within booking workflows while ensuring message relevance and completion guidance effectiveness. The notification process includes incomplete consultation booking reminders that are contextual to the specific stage of the flow through sophisticated stage-aware messaging systems that analyze user progress and generate appropriate intervention content based on workflow position and completion requirements. The contextual customization architecture implements stage-specific messaging templates that address distinct completion scenarios including initial scheduling reminders for users who have browsed designer availability but not selected time slots, measurement submission prompts for users who have confirmed scheduling but not provided dimensional data, and payment completion messages for users who have progressed through scheduling and measurement stages but abandoned transaction processing.

As further shown in FIG. 12, the contextual notification system incorporates workflow-aware content generation that references specific booking elements and completion requirements while providing targeted guidance that addresses stage-specific completion barriers and user concerns. The stage-specific messaging architecture utilizes user progress analysis to determine appropriate reminder timing and content emphasis while coordinating with booking workflow systems to ensure message accuracy and completion pathway clarity. The step 1240 provides adaptive messaging frameworks that adjust reminder content based on time elapsed since workflow abandonment while incorporating urgency indicators and completion incentives that encourage booking finalization without compromising user experience quality. The contextual customization system implements feedback integration that monitors reminder effectiveness across different workflow stages while optimizing message content and delivery timing based on completion conversion outcomes and user response patterns.

The incomplete consultation booking management system architecture incorporates comprehensive analytics capabilities that monitor booking completion rates, abandonment patterns, and reminder effectiveness across different user segments and workflow stages to guide system optimization and user experience enhancement activities. The analytics framework tracks completion conversion rates following reminder delivery while analyzing user response patterns and workflow resumption behaviors that inform messaging strategy refinement and intervention timing optimization. The monitoring system provides detailed performance assessment regarding reminder effectiveness across different abandonment scenarios while identifying workflow friction points that contribute to booking incompletion and user experience degradation. The architecture incorporates machine learning algorithms that analyze booking completion patterns and user behavior indicators to predict abandonment likelihood and optimize proactive intervention strategies that prevent workflow abandonment before completion gaps occur.

Referring to FIG. 13, the process 1300 establishes a comprehensive order delivery progress update framework that provides users with real-time information about custom order advancement through milestone-based notification systems and designer workflow integration capabilities. The process 1300 operates through sequential communication stages that coordinate designer status updates with automated user notification delivery while maintaining transparency throughout extended custom order fulfillment periods. The order progress tracking architecture incorporates milestone detection algorithms that identify significant production stages and trigger corresponding user communications through integrated notification delivery systems. The process 1300 connects with designer workflow management platforms, user communication infrastructure, and order tracking databases to provide comprehensive status monitoring and progress reporting capabilities across diverse custom order types and production timelines.

The step 1310 initiates the progress update sequence when designers update order status following confirmation events, documenting production advancement through various fulfillment stages including cutting completion, fitting progress, stitching activities, and quality assurance processes. The designer update mechanism provides structured interface elements that enable service providers to record milestone achievements through categorized status selection systems and progress documentation tools. The status update architecture incorporates predefined milestone categories that standardize progress reporting across different designer workflows while accommodating custom project specifications and production methodologies. The step 1310 integrates with designer dashboard systems to provide streamlined status update functionality that minimizes administrative burden while ensuring comprehensive progress documentation and user communication coordination.

With continued reference to FIG. 13, the designer status update system implements comprehensive milestone tracking that documents production phases including initial design development, material procurement, pattern creation, cutting operations, construction activities, fitting sessions, finishing processes, and quality control assessments. The milestone documentation architecture provides designers with detailed progress categories that enable precise status communication while supporting diverse production workflows and custom order specifications. The update interface incorporates timestamp recording that documents milestone completion times while providing estimated completion projections for subsequent production phases based on designer workflow analysis and historical performance data. The step 1310 incorporates progress validation mechanisms that ensure status updates align with realistic production timelines while preventing premature milestone reporting that compromises user expectation management and delivery coordination accuracy.

The step 1320 implements sophisticated notification delivery systems that generate push notifications and in-app messages at each production milestone while providing users with detailed progress information and estimated completion updates throughout custom order fulfillment processes. The notification generation architecture analyzes designer status updates and automatically triggers corresponding user communications that reference specific milestone achievements and provide contextual progress information. The messaging system incorporates dynamic content assembly that combines milestone data with personalized communication elements including order specifications, designer information, and estimated delivery timeframes. The step 1320 provides multi-channel notification delivery through push notification systems, email communications, and in-application messaging interfaces that ensure message visibility across different user engagement patterns and device usage preferences.

As further shown in FIG. 13, the milestone notification system incorporates progress visualization elements that enable users to understand order advancement through graphical progress indicators, timeline displays, and completion percentage calculations that provide intuitive status comprehension. The notification content generation utilizes milestone-specific messaging templates that adapt communication tone and information emphasis based on production stage characteristics while maintaining consistent brand voice and professional communication standards. The step 1320 integrates with user preference management systems to customize notification frequency and delivery methods based on individual communication preferences while ensuring critical milestone updates reach users regardless of preference settings. The notification architecture incorporates delivery confirmation tracking that monitors message receipt and engagement while providing fallback communication methods when primary notification channels experience delivery failures or user accessibility issues.

The step 1330 establishes comprehensive completion notification systems that generate delivery confirmation prompts and review request messaging when custom orders reach final fulfillment stages and delivery completion events. The completion notification architecture incorporates delivery tracking integration that coordinates with shipping systems and designer confirmation processes to ensure accurate completion timing and user communication synchronization. The prompt generation system creates personalized completion messages that reference specific order details, designer information, and project specifications while encouraging user feedback submission and experience evaluation activities. The step 1330 provides structured review request functionality that guides users toward comprehensive feedback submission through rating interfaces and testimonial composition tools that support marketplace transparency and designer reputation development.

With continued reference to FIG. 13, the completion prompt system incorporates delivery confirmation validation that ensures notification timing aligns with actual order receipt rather than shipping estimates or designer completion reports to prevent premature review requests that compromise feedback accuracy and user experience quality. The review request architecture implements timing optimization algorithms that schedule feedback prompts during periods of high user engagement while avoiding immediate post-delivery messaging that prevents adequate evaluation time and considered feedback development. The step 1330 integrates with the review and rating infrastructure to provide seamless transitions from completion notifications to feedback submission interfaces while preserving order context and designer information throughout the evaluation process. The completion notification system incorporates follow-up messaging sequences that deliver reminder prompts for users who do not respond to initial review requests while maintaining respectful communication frequency that supports feedback collection without compromising user experience standards.

The order progress notification architecture incorporates comprehensive analytics capabilities that monitor notification effectiveness, user engagement patterns, and communication optimization opportunities across different milestone categories and designer workflow types. The analytics framework tracks notification open rates, user response patterns, and milestone communication effectiveness while analyzing delivery timing optimization and content personalization outcomes that inform system refinement and user experience enhancement activities. The monitoring system provides detailed performance assessment regarding milestone notification accuracy, delivery timing effectiveness, and user satisfaction indicators that guide communication strategy development and notification system optimization. The architecture incorporates machine learning algorithms that analyze user response patterns and engagement outcomes to optimize notification timing, content emphasis, and delivery method selection for individual users while maintaining consistent communication quality and milestone reporting accuracy across diverse custom order fulfillment scenarios.

The process 1300 integrates with broader platform notification systems to coordinate milestone communications with other user engagement messaging including abandoned browsing reminders, consultation booking prompts, and marketplace update notifications while preventing communication overlap and notification fatigue that compromises user experience quality. The integration architecture implements notification scheduling coordination that spaces different message types appropriately while prioritizing milestone updates and delivery notifications over promotional or engagement messaging during active order fulfillment periods. The milestone notification system incorporates user communication preference analysis that adapts messaging frequency and content emphasis based on individual engagement patterns while ensuring critical order progress information reaches users regardless of general notification preferences or communication frequency limitations established through account settings and previous interaction feedback.

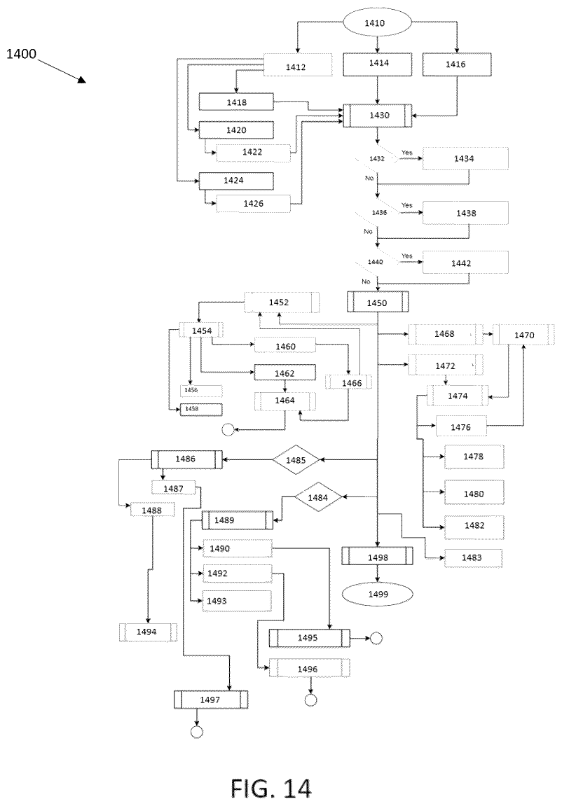

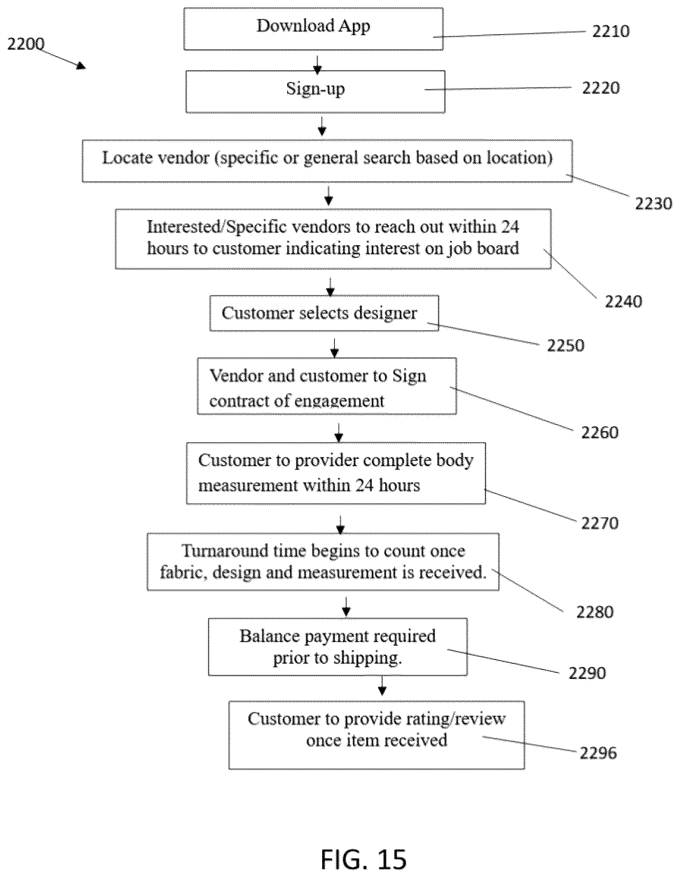

Another embodiment of the platform 1400 shown in FIGS. 14 and 15 includes a mobile/web application which serves as a platform for designers and tailors to showcase their work and allows customers to book for consultations, take fittings, place orders and have them delivered wherein the platform offers a fabric marketplace where sellers can list their products.

The specific goals of the fashion app are to help bring couture and ready-to-wear fashion, fashion designers, and fabric sellers to one place to serve a wide range of customers. The Fashion app will be versatile in creating a market for Fabric sellers and textile manufacturers to display their products, tailors to showcase catalogs of sewn clothes, and designers can sell, and collaborate with tailors and fabric sellers. Target users of the fashion app include print fabric sellers including both local artisans and international vendors, contributing to a vibrant marketplace and multi-fabric sellers embracing diversity, catering to the preferences of users from various backgrounds and regions. Target users of the fashion app include international and local fashion designers offering a platform for skillful tailors to showcase their work to a global audience and clients encompassing both local and international consumers seeking unique, culturally rich fashion. The target users of the fashion app include fashion designers welcoming local and international talents, fostering collaboration with tailors and fabric sellers. A start selection 1410 brings the user to a “I'm Just Browsing” selection 1412, a “I'm a Designer” selection 1414, and an “I'm a Fabric Vendor” selection 1416. Selection of the

“I'm Just Browsing” selection 1412 brings the user to a “Looking for Designers” selection 1418, a “Looking for Designs” selection 1420, a “Sample Designs” selection 1422, a “Looking for Fabrics” selection 1424, a “Samples Fabric” selection 1426. Next, a sign-up selection 1430 allows the user to make a selection 1452 as to if the user is a customer. If the user is a customer, then a customer questionnaire 1434 must be completed before a selection 1436 can be made. Selection 1436 allows the user to choose if the user is a designer. If the user is a designer, then a designer questionnaire 1438 must be completed before a selection 1440 can be made. Selection 1440 allows the user to choose if the user is a vendor. If the user is a vendor, then a vendor questionnaire 1442 must be completed before logging 1450. The following selections are provided in the platform 1400 as shown in FIG. 14 and may follow flow patterns other than those depicted by flow arrows. Selections on the application include: Search/View Fabrics 1452, Fabric Page 1454, Add to Wishlist 1456, Share 1458, Add to Cart 1460, One-click purchase 1462, Checkout 1464, Cart 1466, Search/View Designs 1468, Design Page 1470, Search/View Designers 1472, Designer Page 1474, Portfolio Page 1476, Measurement Guides 1478, 1493, Request a Quote 1480, Schedule Consultation 1482, Wishlist 1483, Choice 1484 if user is a designer, Choice 1485 if user is a vendor, Seller Center 1486, 1489, View Orders 1487, View Products 1488, Appointment 1490, Portfolio 1492, 1493, Product page 1494, Appointment Page 1495, Design page 1496, Order Page 1497, and Logout 1498. The application then ends 1499. Design Considerations-User Behavior: Users are familiar with basic navigation and interaction in web and mobile applications.
Data Availability: Data from external sources is accurate and up to date.
Internet Connectivity: End-users have a reliable internet connection with reasonable bandwidth.
Security Compliance: The organization's security policies and compliance measures are followed during system development.
Budget Allocation: The allocated budget for system design and development is sufficient to meet project requirements.
Third-Party Service Availability: Third-party services and APIs used in the system remain available and continue to support the application.
The backend of the system and the database may be hosted on AWS.
The file storage may be on AWS S3.

Design Methodology—The application utilizes the Model View Controller (MVC) design pattern. The primary purpose of the MVC pattern is to separate an application's concerns into three interconnected components, each responsible for different aspects of the application's functionality. This separation promotes modularity, maintainability, and the ability to make changes to one component without affecting the others.

System Architecture—The system includes a client-server architecture, with the following key components:

A client side includes a mobile application and a web application. Mobile Application (React Native)—The mobile application is for Android and iOS platforms. The mobile application allows fabric sellers, designers, tailors, and customers to access the platform on their mobile devices. The mobile application utilizes responsive design principles for a user-friendly experience. The client side includes a Web Application (React JS) which provides an alternative access point for users on desktop or web browsers and ensures compatibility across major web browsers.

A server side includes an API and a database. The API (PHP: Laravel Framework) manages user authentication and authorization. The API handles business logic, including product listings, portfolio management, order processing, payments and appointment scheduling. Provides RESTful APIs for client-side interactions. The database (MySQL/Microsoft SQL Server—for Enterprise Level) stores user data, product listings, portfolio information, booking details, and messaging data. The database utilizes a relational database management system for structured data storage.

Cloud Storage (Amazon S3 or Google Cloud Storage) stores product images and media files and utilizes cloud-based storage solutions.

Features include user management, fabric marketplace, portfolio management, booking and messaging, and user interfaces.

User Management—User registration and authentication. Role-based access control for sellers, designers, tailors, and customers.

Fabric Marketplace—Sellers can add, edit, and manage fabric product listings. Customers can search for and view product details, add items to a cart, and make purchases. Integration with payment gateways for secure transactions.

Portfolio Management—Designers and tailors can create, edit, and manage their portfolios. Showcase previous work, services offered, and availability for bookings.

Booking and Messaging—Customers can book appointments for consultations and fittings with designers and tailors. In-app messaging to facilitate communication between customers and service providers. Notification system to alert users about new bookings and messages.

User Interfaces—The app consists of three primary user interfaces. A seller interface can be used by Fabric sellers who can use this interface to register and create an account, add, edit, and manage fabric products for sale, and set prices, upload images, and provide product descriptions.

A designer/tailor Interface allows designers and tailors to use this interface to register and create an account, create and manage their portfolio, showcasing their work, services, and availability, receive booking requests from customers, and communicate with customers and schedule consultations and fittings. A customer interface allows customers to use this interface to register and create an account, browse and search for fabric products from sellers, buy products and track their orders, explore designer and tailor portfolios, book appointments for consultations and fittings, and communicate with designers, tailors, and sellers.

Databases may include a staging environment and a production environment including tables which may include entries for users, portfolio items, products, wish list items, reviews, orders, order items, invoices, sales, blocked dates, bookings, dates, and payments.

Database schema includes databases and tables. Table relationships which are based on a one-to-many relationship include users to portfolio items, users to products, users to wish list items, users to orders, users to reviews, users to bookings, users to blocked dates, bookings to dates, orders to order items, invoices to payments, sales to payments, products to order items, products to wish list items, and products to reviews. Table relationships based on a one-to-one relationship include orders to invoices and orders to sales.

Secure storage of user data and sensitive information. Regular security audits and updates to protect against vulnerabilities.

Scalability—The system is designed to handle potential growth, both in terms of users and data. This includes database scaling and efficient use of resources.

Data Privacy and Compliance—The system complies with relevant data privacy laws and have mechanisms for users to control their data.

Performance and Testing—Performance testing should be conducted to ensure the application performs well under various loads. Regular testing, including unit tests, integration tests, and user acceptance tests, should be conducted to maintain quality.

Deployment—The system is deployed on a cloud infrastructure (AWS) for scalability and ease of maintenance.

Maintenance and Support—A plan for ongoing maintenance, bug fixes, updates, and customer support should be in place to ensure a reliable user experience.

The system design specification provides an overview of the mobile and web application for fabric sellers, designers, tailors, and customers. The platform includes bookings, enhancing the experience for all users involved in the fashion industry. The use of React Native and React JS, along with the PHP (Laravel Framework) and MySQL backend, ensures a modern, efficient, and scalable solution.

Some features of the fashion app are as follows.

User Registration and Profiles: Seamless account creation with essential details.

Verification and Validation: Ensures user authenticity and security.

Fashion Designer Profiles: Access to detailed profiles of skilled professionals (They must have an active social media page). Showcasing designer portfolios and creations.

Fabric Catalog: Extensive collection of fabrics for custom choices.

Measurement Guide: Easy guidance for accurate measurements. (Photo Upload, Live Capture (Video sample on how to take the measurement))

Tailor Availability: Real-time availability status of tailors. (Calendar)

Booking and Appointments: Schedule appointments for fittings and consultations. (Post delivery)

Order Placement: Intuitive order creation process.

Shipping Partners: Partnerships for reliable and efficient shipping.

Payment Gateway: Secure transactions for buying and selling.

Customization Options: Personalize fabric prints for unique designs.

Chatbots: Instant communication for quick queries.

Order Tracking: Real-time tracking of order progress.

Portfolio Showcases: Showcasing tailor and designer portfolios.

Product Browsing and Filtering: Easy navigation through products.

Detailed Product Views: In-depth views for informed choices.

Shopping Cart and Checkout: Seamless purchase process.

Order Tracking and Notifications: Updates on order status.

User Reviews and Ratings: Insights from others' experiences.

Search Functionality: Quick product search.

Push Notifications: Alerts on new arrivals and promotions.

Social Sharing and Engagement: Sharing options for social platforms.

Size Recommendations: AI-driven size suggestions.

Virtual Fitting Room: Trying on clothes virtually.

Style AI Recommendations: Personalized style recommendations.

Sustainability Insights: Information on eco-friendly materials.

3D Product Views: Enhanced product visualization.

Exclusive Designer Collections: Special collections from designers.

Try-Before-Buy Subscription: Subscription-based try-before-buy option.

Augmented Reality Fashion Shows: Immersive virtual fashion events.

Fashion AI Trends: AI-driven trend forecasts.

Custom Fabric Printing: Printing own designs on fabrics.

Live Designer Q&A Sessions: Direct interaction with designers.

Visual Wardrobe Organizer: Organizing purchased items.

Eco-Friendly Material Filters: Sorting by sustainable materials.

User Wishlist and Favorites: Saving preferred items.

One-Click Purchases: Streamlined purchasing process.

Live Streaming Fashion Shows: Real-time fashion showcases.

Augmented Reality Accessories: Try-on virtual accessories.

User Feedback Integration: In-app feedback submission.

Size Inclusivity: Catering to diverse body types.

Quick Reorder: Rapid reorder of favorite items.

Video Product Demonstrations: Visual demos of products.

Localized Content: Tailored content for different regions.

User-Generated Challenges: Engaging challenges for users.

In-app Wardrobe Styling: Styling outfits within the app.

Personal Stylist Consultation: Expert style advice.

Features for Fashion Designer Vendors are as follows.

User-friendly Profile Creation: Easy setup of professional profiles.

Detailed Vendor Information: Showcasing expertise, portfolio, and references.

Direct Communication: Message and video boards for client interaction.

Fabric Display: Display fabrics for sale.

Availability Calendar: Displaying availability for bookings.

Star Rating System: User-driven ratings for vendor credibility.

Shipping Profile Management: Control over the shipping process.

Comments: Access to their social media accounts

Fashion Trends Insights: Access to AI-driven trend forecasts.

No screen capture.

Features for fabric vendors include vendor profile creation for setting up vendor profiles, fabric collections showcasing fabric offerings, shipping profile management for independent management of shipping, and integration with designers whereby options are provided for designers to use vendor fabrics.

The specific requirements for each task are listed as follows.

User interface (UI) design: The UI design should be user-friendly and easy to navigate. It should also be visually appealing and engaging.

User experience (UX) design: The UX design should focus on the user's needs and how they will interact with the app. It should be clear and concise, and it should help users to achieve their goals quickly and easily.

Information architecture (IA): The IA should define the structure of the app's content. It should ensure that the content is organized in a way that is easy for users to find and understand.

Visual design: The visual design should use colors, fonts, and other elements to create a cohesive and visually appealing look and feel for the app.

Accessibility: The app should be accessible to users with disabilities. This includes features such as text-to-speech and high-contrast mode.

Task: User Registration and Authentication-Requirements: Users can register using email or social media accounts. Registration form includes fields for name, email, password, and profile picture. Passwords must meet security criteria (e.g., minimum length, special characters). User data (excluding passwords) is stored securely in the database. Users can log in with registered credentials. Forgot password functionality allows users to reset their passwords via email.

Task: Product Browsing and Filtering-Requirements: App displays a categorized product list on the home page. Users can click on categories to view specific product listings. Filtering options include price range, size, color, and category. Filtered results update dynamically without requiring page reloads. Users can sort products by relevance, price, and popularity. Task: Product Details and Imagery. Requirements: Each product listing includes a product name, price, description, and images. Users can view high-resolution images by clicking on product thumbnails. Zoom functionality allows users to see product details.

Task: Shopping Cart and Checkout-Requirements: Users can add products to the shopping cart. Cart icon displays the number of items added. Cart page lists selected items, quantities, and total cost. Users can adjust quantities or remove items from the cart. Secure checkout process with payment options (e.g., credit card, PayPal). User receives an order confirmation email.

Task: User Profiles and Order History-Requirements: Each user has a profile page displaying personal information. The profile page also shows order history and current order status. Users can click on orders to view detailed order information. Users can initiate returns for products in a specified timeframe.

Task: Search Functionality—Requirements: App includes a search bar for users to search for products. Search results display matching products in real time. Results can be filtered and sorted similarly to regular product listings.

Task: Push Notifications—Requirements: App sends push notifications for order confirmations, promotions, and price alerts. Users can opt-in/out of notifications in their profile settings. Notifications are platform-specific (e.g., iOS, Android).

Task: Social Sharing and Reviews-Requirements: Users can share products on social media platforms. Product listings display average ratings and reviews. Users can leave reviews and star ratings for products they've purchased.

The dependencies between tasks are:

User Registration and Profile Setup: Dependency: Users must register and set up profiles before they can upload measurements and photos.

User Uploading Measurements and Full Body Photos (Users): Dependency: Users need to upload accurate measurements and full body photos before customization can be accurately performed.

Size Conversion Options (Developers): Dependency: Developers need to integrate size conversion options (UK, US, CHN) after receiving user measurements. (Metric Systems (inches, cm, m |Lbs. vs Kgs))

Designing Customization UI (Designers): Dependency: Designers need to finalize the customization interface after size options are integrated.

Integrating Fashion Designer Profiles (Developers): Dependency: Tailor and designer profiles can be integrated once profiles are set up and customization is finalized.

User Customization (Users): Dependency: Users can customize products only after measurements are uploaded and size options are integrated.

Fabric Services Integration (Developers): Dependency: Developers need accurate customization data before integrating fabric availability from fabric services.

Tailoring Orders and Scheduling (Tailors): Dependency: Tailors need precise customization data to fulfill orders accurately.

User Reviews and Feedback (Users): Dependency: Users can leave reviews and feedback after experiencing the customization process and receiving orders.

Quality Check and Testing (QA Team): Dependency: Tailoring orders need to be accurately processed for quality check, considering customization accuracy.

App Maintenance and Updates (Developers): Dependency: Ongoing coordination with tailors, designers, and fabric services for updates and maintenance.

User Education on Customization (Marketing & Developers): Dependency: Marketing needs accurate customization details to effectively promote this feature.

Fabric Services and Inventory Updates (Fabric Services): Dependency: Fabric services need to update inventory based on customization trends and orders.

Workflow—Initiation Stage: Clients-Define Goals and Scope (Day 1-Day 3). Clients outline project goals and scope, emphasizing the app's couture and ready-to-wear fashion, Contemporary fashion, tailor, fabric seller, and designer integration. Metrics: Clearly defined project goals and scope.

Register company: The clients should register their company with the relevant authorities. Pick a color theme: The clients should pick a color theme for the fashion app. This will help developers to create a consistent and cohesive look and feel for the app. Logo sketch: The clients should create a logo sketch for the fashion app. This will help developers to define the visual identity of the app. Developers: Project Kickoff (Day 1). The project manager conducts a kickoff meeting to introduce the team, establish expectations, and align everyone with project objectives. Metrics: Successful project kickoff and team alignment.

Requirements Gathering Stage: Clients: Provide User Personas and Stories (Day 4-Day 7). Clients submit detailed user personas and stories to set the foundation for functional requirements. Metrics: Completed user personas and stories documentation.

Developers: 2. Analyze User Personas and Stories (Day 8-Day 10). The development team thoroughly examines user personas and stories to extract functional requirements. Metrics: Comprehensive analysis of user personas and stories.

Design Stage-Clients: Review and Approve Wireframes (Day 11-Day 14). Clients evaluate and endorse wireframes and prototypes that illustrate the app's layout and structure. Metrics: Approved wireframes and prototypes Developers: Develop User Interface (UI) (Day 15-Day 20). UI designers craft the app's user interface according to the approved wireframes. Metrics: Completed UI design phase.

Development Stage—Clients: Provide Fabric Catalog Data (Day 21-Day 25). Clients supply data for the fabric catalog, contributing to the app's material diversity. Metrics: Fabric catalog data integration. Developers: Integrate Fabric Catalog (Day 26-Day 30). Developers seamlessly integrate the fabric catalog feature, enabling users to explore available textiles. Metrics: Successful fabric catalog integration.

Deployment Stage—Clients: Provide Designer Profiles and Catalogs (Day 31-Day 35). Clients furnish data for designer profiles and catalogs, enhancing the app's designer-centric functionality. Metrics: Designer profiles and catalog data integration. Developers: Integrate Designer Profiles and Catalogs (Day 36-Day 40). Developers merge designer profiles and catalogs into the app, fostering connections between users and designers. Metrics: Successful designer profiles and catalog integration.

Maintenance and Support Stage—Clients: User Testing and Feedback (Day 41-Day 45). Clients conduct user testing and gather feedback, ensuring user-centric design and functionality. Metrics: Comprehensive user feedback collection.

Developers: Refinement and Bug Fixing (Day 46-Day 50) The development team refines the app based on user feedback, addressing bugs and enhancing user experience. Metrics: User feedback addressed, enhanced app functionality.

Quality Check and Assurance Stage—Clients: Review Final App Version (Day 51-Day 55). Clients review the final app version, verifying alignment with project goals and requirements. Metrics: Final app version approval Developers: Quality Assurance Testing (Day 56-Day 60). The QA team conducts rigorous testing to ensure the app's performance, usability, and absence of errors. Metrics: Successful QA testing, and error resolution.

Launch Stage—Clients: Launch Preparation (Day 61-Day 65)—Clients prepare for the app's launch, devising marketing strategies and ensuring optimal user experiences. Metrics: Launch plan readiness Developers: App Deployment and Launch (Day 66-Day 70) developers deploy app-to-app stores, making it available to users for download and usage. metrics: Successful app deployment and launch.

Post-Launch Stage—Clients: Monitor User Engagement (Ongoing)—Clients analyze user engagement metrics, assess user feedback, and ensure ongoing user satisfaction. Metrics: Tracked user engagement metrics, user feedback integration Developers: Continuous Monitoring and Updates (Ongoing) The development team consistently monitors app performance, attends to user issues, and introduces updates. Metrics: App performance vigilance, updates implementation.

The present invention is directed to an app for IOS and Android, and a website for providing a platform for connecting fashion lovers with talented fashion designers that can deliver exactly what the client wants. Many people in the diaspora struggle with access to good and exceptional fashion designers who are readily available to make and deliver quality custom-made clothing.

With the platform, people living in the US and Canada, though not only limited to these locations, can have access to these designers located in the US, Canada, Nigeria, Ghana, as well as other feasible locations. The choice is up to the customer to decide which fashion designer to work with and these designers is pre-selected and signed up on the platform.

The platform is a designer/vendor platform as well as User/Customer platform. Vendors go through a pre-qualification process to ensure they meet the vision, core values and standards, which includes—professionalism, integrity, speed, reliability, excellence, superior quality, positive customer experience, to name a few. A profile is created for each designer and whenever a customer's request comes in, they are able to respond to the customer requests until the order is closed.

The platform includes an option for designers to display fabrics on sale, which the customer can decide to purchase. These fabrics are sold per yard, and are either be sold by the respective vendors or the holding company of the app.

The types of clothing to be designed and sewn include custom/couture fashion for men, women and children, as well as contemporary Western clothing, dinner gowns, etc.

The target market includes-Male and female custom/couture fashion lovers in the diaspora with more focus on the US and Canadian market, but open to Europe and Africa as well. All ages—young (Minor—Guardian triggered) and adults. Users must be above 18 yrs. to sign up for the app. Fashion designers as vendors in US, Canada, Nigeria and Ghana for phase 1 and others outside of these geo-physical locations for phase 2.

Features for Customer—The customer provides a username and password in order to create an account. The customer's basic profile includes full names, mailing address, email, and a profile picture. At time of intent to purchase, the customer submits a short description of the desired clothing, pictures of the clothing design (to include, front, back and side views), body measurements, and preferred turn-around time. The app includes a minimum list for body measurements for the customer to provide and includes AI technology integrated in the app to transcribe body measurements from recently uploaded pictures of the customers or body scan via camera. The app includes a message and video board for direct contact with respective designers as well as a payment platform

Features for Designer Vendor—The vendor provides a username and password to create a profile. The vendor basic profile includes full names, location, a short description of the vendor company and capabilities, work portfolio (including pictures), references, and a video introducing themselves and their work. A message and video board-audio and video capabilities, maybe zoom-integrated. An option for designers to display their fabrics for sale to potential customers. An active calendar that shows designers' availability. A star rating portion which customer has access to post-delivery of their clothing. If the vendor rating goes below 3.5, a warning is given, and when below 3.0, vendor is automatically removed from the platform. The ability to create a shipping profile which they manage independently. Incentives are given to designers who manage shipping of their products.

Features for fabric Vendors (similar to Esty or the like)—The vendor creates a profile. The vendor has a collection of fabrics available to be sold per yard or in bundles. The ability to create a shipping profile which the vendor manages independently. Incentives are given to vendors who manage shipping of their products.

Customers also have the option of shipping their fabrics to their selected designers. However, in the absence of this, there is an option of fabrics sold by the fashion designer/vendors.

App Security and Verification-A solid Tech backbone is deployed with high security to ward-off scammers and hackers. A secure server with adequate capacity to accommodate contents and app processes is deployed. This is a paid service. Any member that wants to join has to pay the associated fee. There is no free trial at any point in time because of regions of operation. The platform may include a ‘free or trial package’ with limited features at the initial stage of the app. Any suspected fraudulent activity is flagged, reported and blocked, same applies for suspicious profiles. The tech deployed should be able to intelligently detect this. A ‘report’ button for members is needed so they can flag or report suspicious accounts that tech team may miss but it should be advised that this button be used sparingly and not in retaliation or annoyance. There is no exchange of contact details such as phone numbers or emails until a certain milestone is reached and also depending on the package selected. Phone numbers and emails is encrypted if a member includes this in any contact. All communication is done through the app. A toll-free number is available for customer support. A chat box feature is available should customers have initial questions prior to committing to signing up/creating a profile. A “contact us” button is available for registered members. Terms of use, FAQ, privacy, success tips, success stories are visibly displayed. An NDA/Non-circumvent agreement shall be in place in the app between customers, vendors (designers and fabric suppliers). A good UI and UX is paramount. The UI is extremely important and should portray just enough of what is required. UX should be so exciting and plays a major role in user retention especially for first time visitors just to satisfy curiosity. Designers must have an active social media page, be tech savvy, and own a smart device. Customer can contact ALL designers (job board e.g. like Upwork) or can select specific designers. Vendors need to respond within 24 hours, otherwise, their rating drops if customers message specific designers. An OTP verification (email or text message) would be validated upon account sign-up for all users.

Business Model and Strategy-Company identifies fashion designers (who have their own tailors/seamstresses) in North America, UK, Nigeria and Ghana for phase 1. The company needs to have a document detailing information about the fashion app and expectations to provide to these designers to help them make an informed decision. An animated video showing interested customers/vendors what to expect from creating a profile to product delivery. Pricing: The designers determine the sales price of their product and the company applies a percentage commission (15-20%). Shipping: The designer and/or company is responsible. An A-Star rating is added to the profiles of designers that take on shipping responsibilities (i.e. A-rate designers). Client Search: social media, paid campaigns and influencers, giveaways, billboard adverts, brand ambassadors (local and international), PR Companies. The company determines turn-around time (14 calendar days, excluding shipping), with the option of expedited services (7 calendar days, excluding shipping), once fabric, design and measurements are provided/available. A 60% down payment is required by the customer once terms of engagement is signed. The outstanding balance is paid prior to shipping. The designers need to be open to making amendments post-shipping irrespective of which designer produced the initial product.

FIG. 15 shows a flowchart 2200 of an example of a customer in a specific location sourcing customized clothing. The designers need to be open to making amendments post-shipping irrespective of which designer produced the initial product. The steps include downloading the app 2210, and signing up as a customer 2220. The steps include locating a vendor 2230 (specific or general search based on location) and interested/specific vendors to reach out within 24 hours to customer indicating interest on job board communication 2240. The steps include the customer selecting a designer 2250, the vendor and customer signing the contract of engagement 2260, and the customer to provide complete body measurement within 24 hours 2270. The steps include the turnaround time beginning to count once the fabric, design and measurement is received 2280 and the balance payment made prior to shipping 2290. The steps may include the customer providing rating/review once item received 2296.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A digital fashion marketplace platform, comprising:
a server system configured to host a global fashion marketplace connecting consumers with designers and tailors;
a user interface module configured to facilitate user registration and authentication for both consumers and fashion service providers;
a designer portfolio management system configured to enable designers and tailors to create and maintain digital portfolios showcasing their work and services;
a custom order workflow engine configured to process custom clothing requests through flexible communication options including direct messaging and scheduled consultations;
an artificial intelligence-powered body measurement system configured to analyze user-provided images to generate body measurements for custom clothing orders;
a real-time communication module configured to facilitate text messaging, image sharing, and video consultations between consumers and designers;
a verification system configured to authenticate designer credentials through document processing and verification services;
an artificial intelligence chatbot configured to provide automated customer assistance and product recommendations;
a recommendation engine configured to analyze user behavior data to generate personalized suggestions for designers, fabrics, and designs;
a fabric and product marketplace module configured to facilitate sales of fabrics, ready-to-wear clothing, and accessories;
a review and rating system configured to enable verified purchasers to rate and review designers and completed orders; and
a notification system configured to generate contextual pop-up messages and push notifications based on user interaction patterns and order status updates.

2. The digital fashion marketplace platform of claim 1, wherein the custom order workflow engine is configured to present users with a prompt offering two distinct communication options comprising scheduling a consultation and sending a direct message to a designer.

3. The digital fashion marketplace platform of claim 2, wherein the scheduled consultation option includes a calendar interface displaying designer availability and time slot selection mechanisms for coordinated video communication sessions.

4. The digital fashion marketplace platform of claim 1, wherein the artificial intelligence-powered body measurement system is configured to process full-body photographs through computer vision algorithms that identify anatomical landmarks and calculate dimensional measurements including chest, waist, and hip measurements.

5. The digital fashion marketplace platform of claim 4, wherein the artificial intelligence-powered body measurement system further comprises a manual editing interface that enables users to modify generated measurements and a storage system configured to preserve dimensional data for reuse in future orders.

6. The digital fashion marketplace platform of claim 1, wherein the verification system is configured to process designer documentation through an external API service and assign verified badges to designer profiles upon successful authentication of identification documents, business documentation, and regulatory compliance certificates.

7. The digital fashion marketplace platform of claim 1, wherein the notification system is configured to generate abandoned browsing reminders when users exit designer profiles or product pages without completing purchase actions, wherein the reminders are limited to a maximum of two notifications per viewed item to prevent user experience degradation.

8. A method for facilitating custom fashion orders through a digital marketplace platform, comprising:
receiving a user selection of a designer from a marketplace interface;
presenting a prompt offering communication options including scheduling consultation and sending direct message to the designer;
processing the user's communication preference selection to activate corresponding interaction systems;
enabling message transmission functionality where users can communicate about fabric ideas and design references with designers;
implementing fabric selection mechanisms from available options including designer catalogs, marketplace inventory, and user-provided materials;
facilitating measurement provision through artificial intelligence-powered body measurement analysis of user-provided images;
processing designer responses containing quotations and estimated timeline information;
managing user review and acceptance processes for quotations and project specifications;
processing secure payment completion through integrated gateway systems; and
implementing order tracking functionality with status updates through notification systems.

9. The method of claim 8, wherein the artificial intelligence-powered body measurement analysis comprises uploading full-body photographs or using live camera capture, processing the images through computer vision algorithms to identify anatomical landmarks, and generating key measurements including chest, waist, and hip dimensions.

10. The method of claim 9, wherein the artificial intelligence-powered body measurement analysis further comprises displaying the generated measurements for user confirmation with manual editing options and storing the measurements for reuse in future orders.

11. The method of claim 8, wherein presenting the prompt offering communication options comprises displaying a scheduling interface with designer availability calendars and time slot selection mechanisms when the consultation option is selected.

12. The method of claim 11, wherein the scheduling consultation further comprises conducting video call sessions through integrated video conferencing systems and preserving notes and file attachments within order threads following consultation completion.

13. The method of claim 8, wherein implementing fabric selection mechanisms comprises presenting organized catalog displays showcasing available materials through high-resolution imagery, detailed specifications, pricing information, and availability status indicators.

14. The method of claim 8, wherein implementing order tracking functionality comprises generating milestone-based notifications when designers update order progress through production stages including cutting completion, fitting progress, and delivery coordination.

15. A method for providing artificial intelligence-powered body measurements in a fashion marketplace platform, comprising:
prompting a user to add measurements during order creation processes;
enabling image capture functionality through full-body photo uploads or live camera capture mechanisms;
implementing artificial intelligence analysis that processes captured imagery to generate body measurements including chest, waist, and hips through computer vision algorithms;
displaying measurement results for user confirmation with manual editing options available;
storing measurements in a user profile for reuse in future order processes; and
communicating privacy protection measures through user notification systems that inform users about secure image processing and data handling protocols.

16. The method of claim 15, wherein the artificial intelligence analysis utilizes machine learning models trained on diverse body types and photographic conditions to ensure accurate dimensional calculations across varied user populations.

17. The method of claim 16, wherein the computer vision algorithms identify anatomical landmarks and calculate proportional relationships to generate additional dimensional measurements including shoulder width, arm length, and inseam measurements.

18. The method of claim 15, wherein enabling image capture functionality comprises providing positioning guidance overlays and lighting assessment algorithms that evaluate image quality parameters to ensure optimal capture conditions for artificial intelligence processing.

19. The method of claim 18, wherein the positioning guidance overlays include visual indicators that direct users to maintain specific body positions and camera distances during image capture to optimize measurement accuracy.

20. The method of claim 15, wherein storing measurements in the user profile comprises maintaining measurement histories that document collection dates and data sources while providing cross-device synchronization through cloud-based storage systems.
